(19) United States
(12) Patent Application Publication
(10) Pub. No.: US 2025/0133301 A1
(43) Pub. Date: Apr. 24, 2025

(54) INFORMATION PROCESSING SYSTEM, INFORMATION PROCESSING METHOD, AND NON- TRANSITORY RECORDING MEDIUM

(71) Applicant: Yoshihiko ABE, KANAGAWA (JP)

(72) Inventor: Yoshihiko ABE, KANAGAWA (JP)

(21) Appl. No.: 18/820,345

(22) Filed: Aug. 30, 2024

(30) Foreign Application Priority Data
Oct. 18, 2023 (JP) 2023-179586

(51) Int. Cl. H04N 23/88; G06T 7/90

(52) U.S. Cl. CPC H04N 23/88; G06T 7/90

(57) ABSTRACT

An information processing system includes a first system that performs color adjustment on an image forming apparatus and a second system that provides a service related to the adjustment. The first system includes first circuitry that transmits to the second system a request for assistance with an issue in the adjustment. The second system includes second circuitry that acquires first information related to an operation of the image forming apparatus and second information related to the adjustment, and a memory that stores the first and second information. In response to the request, the second circuitry causes a first display device used by a service provider of the service to display an assistance screen that displays information for supporting resolution of the issue based on information of the request included in the first and second information, and notifies the first system of a response input by the service provider.

### CROSS-REFERENCE TO RELATED APPLICATIONS

This patent application is based on and claims priority pursuant to 35 U.S.C. § 119 (a) to Japanese Patent Application No. 2023-179586, filed on Oct. 18, 2023, in the Japan Patent Office, the entire disclosure of which is hereby incorporated by reference herein.

### BACKGROUND

### Technical Field

Embodiments of this disclosure relate to an information processing system, an information processing method, and a non-transitory recording medium.

### Related Art

Color adjustment on a printer that performs a print job may include a process of color sample matching to adjust the color reproducibility of the printer to match the color of a print sample already existing as a printed material and a process of causing a colorimeter to read a color chart printed by the printer and adjusting the print output to obtain a color difference corresponding to intended quality. This type of color adjustment is expected to be performed by a user of the printer with special software based on a colorimetric result obtained from the colorimeter. The color adjustment, however, involves technical knowledge and experiences, and may yield varied results if performed by an operator with insufficient expertise.

### SUMMARY

In one embodiment, there is provided an information processing system that includes, for example, a first system that performs color adjustment on an image forming apparatus and a second system that provides a service related to the color adjustment. The first system includes first circuitry that transmits a request for assistance with an issue related to the color adjustment to the second system in accordance with an operation performed by a user of the image forming apparatus. The second system includes second circuitry and a memory. The second circuitry acquires first information related to an operation of the image forming apparatus and second information related to the color adjustment. The memory stores the first information and the second information. In response to receipt of the request, the second circuitry causes a first display device used by a service provider of the service to display an assistance screen that displays information for supporting resolution of the issue related to the color adjustment based on information included in the first information and the second information and corresponding to the request. The second circuitry further notifies the first system of a response input by the service provider as a response to the request.

In one embodiment, there is provided an information processing method that includes, for example, acquiring first information related to an operation of an image forming apparatus and second information related to color adjustment performed on the image forming apparatus, and storing the first information and second information in a memory. In response to receipt of a request for assistance with an issue related to the color adjustment, the request being transmitted in accordance with an operation performed by a user of the image forming apparatus, the method further includes causing a display device used by a service provider of a service related to the color adjustment to display an assistance screen that displays information for supporting resolution of the issue related to the color adjustment based on information included in the first information and second information and corresponding to the request, and notifying a response input by the service provider as a response to the request.

In one embodiment, there is provided a non-transitory recording medium storing a plurality of instructions which, when executed by one or more processors, causes the one or more processors to perform the above-described information processing method.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an exemplary general arrangement of an information processing system according to an embodiment;

FIG. 2 is a diagram illustrating an exemplary hardware configuration of an image forming apparatus included in the information processing system of the embodiment;

FIG. 3 is a diagram illustrating an exemplary hardware configuration of a color adjustment system or another system or terminal included in the information processing system of the embodiment;

FIG. 4 is a diagram illustrating an exemplary configuration of functional blocks of the information processing system of the embodiment;

FIG. 5 is a diagram illustrating an overview of the operation of the information processing system of the embodiment;

FIG. 6 is a table illustrating an example of color adjustment history information of the embodiment;

FIG. 7 is a table illustrating an example of operation history information of the embodiment;

FIG. 8 is a diagram illustrating an example of a device color adjustment result screen of the embodiment displayed on a terminal of a printing company;

FIG. 9 is a diagram illustrating an example of a job color adjustment result screen of the embodiment displayed on the terminal of the printing company;

FIG. 10 is a diagram illustrating an example of an assistance request screen of the embodiment displayed on the terminal of the printing company;

FIG. 11 is a diagram illustrating an example of a device color adjustment assistance screen of the embodiment displayed on a terminal of a service provider when an adjustment result tab is selected;

FIG. 12 is a diagram illustrating an example of the device color adjustment assistance screen of the embodiment displayed on the terminal of the service provider when an analysis tab is selected;

FIG. 13 is a diagram illustrating an example of the device color adjustment assistance screen of the embodiment displayed on the terminal of the service provider when a logs tab is selected;

FIG. 14 is a diagram illustrating an example of the device color adjustment assistance screen of the embodiment displayed on the terminal of the service provider when an assistance tab is selected;

FIG. 15 is a diagram illustrating an example of a job color adjustment assistance screen of the embodiment displayed on the terminal of the service provider when an adjustment result tab is selected;

FIG. 16 is a diagram illustrating an example of the job color adjustment assistance screen of the embodiment displayed on the terminal of the service provider when an assistance tab is selected;

FIG. 17 is a diagram illustrating an example of an assistance request screen of the embodiment displayed in response to receipt of a response from the service provider;

FIG. 18 is a sequence diagram illustrating an exemplary procedure of overall operation of the information processing system of the embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, an information processing system, an information processing method, and a non-transitory recording medium according to embodiments of the present disclosure are described in detail below. As used herein, the singular forms “a,” “an,” and “the” are intended to include the plural forms as well, unless the context clearly indicates otherwise.

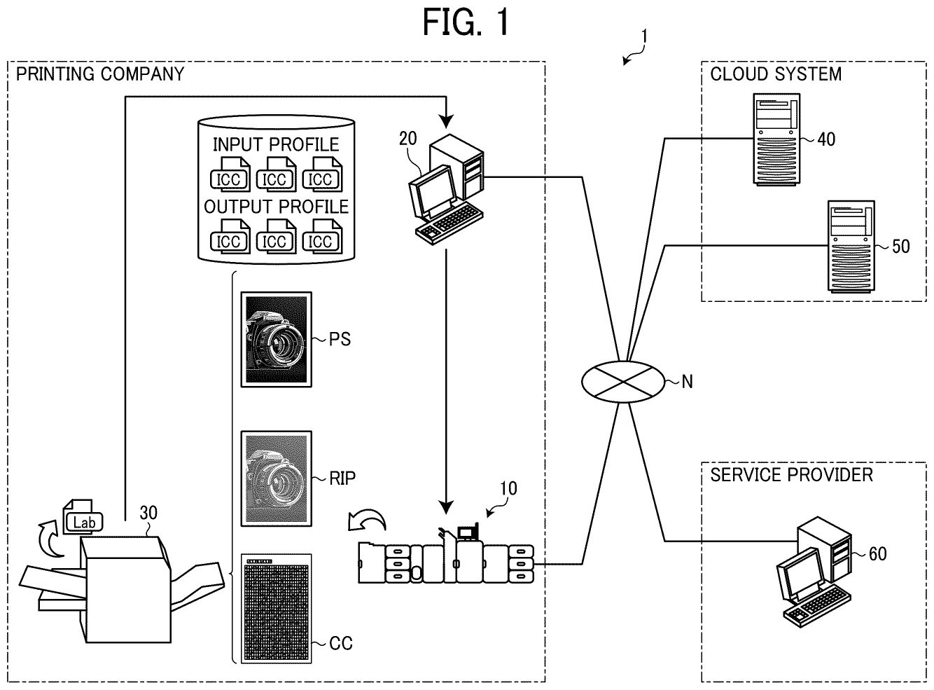

FIG. 1 is a diagram illustrating an exemplary general arrangement of an information processing system 1 according to an embodiment. A general arrangement of the information processing system 1 of the embodiment will be described with reference to FIG. 1.

The information processing system 1 illustrated in FIG. 1 is a system that enables interactive communication between a printing company and a service provider when the printing company requests assistance from the service provider in performing color adjustment with a print sample PS and a color chart CC, for example, and the service provider provides the printing company with guidance and comment, for example, in response to the request. Herein, the term “assistance” means aid, support, or help, for example. As illustrated in FIG. 1, the information processing system 1 includes an image forming apparatus 10, a color adjustment system 20, an image reading apparatus 30, a color adjustment assistance system 40, a device management system 50, and a service provider terminal 60. The image forming apparatus 10, the color adjustment system 20, the color adjustment assistance system 40, the device management system 50, and the service provider terminal 60 are capable of communicating data to each other via a network N. FIG. 1 illustrates a single image forming apparatus 10 for the sake of simplicity of explanation. The configuration of the information processing system 1, however, is not limited thereto. For example, the color adjustment system 20 may manage a plurality of image forming apparatuses 10. Further, the information processing system 1 is not limited to a system for a single printing company (e.g., a system including the image forming apparatus 10, the color adjustment system 20, and the image reading apparatus 30), and may include a plurality of systems for a plurality of printing companies.

The image forming apparatus 10 is an image forming apparatus on which the color adjustment is performed, such as a commercial printing machine, a multifunction peripheral (MFP), or an electrophotographic or inkjet printer equipped with a printer function as a major function thereof. Herein, the MFP is a multifunction peripheral equipped with at least two functions out of a copier function, a printer function, a scanner function, and a facsimile (FAX) function. The color adjustment herein includes device color adjustment (first color adjustment) and job color adjustment (second color adjustment). The device color adjustment is a process performed for each image forming apparatus 10 (or for each sheet printed by the image forming apparatus 10), specifically a process of causing the image reading apparatus 30 to read the color chart CC printed by the image forming apparatus 10 and reducing unevenness in density on a page with read data of the color chart CC. The job color adjustment is color sample matching performed for each print job, specifically a process of causing the image reading apparatus 30 to read the print sample PS as a sample for color reproduction and adjusting the print color to match the color of the print sample PS based on read data of the print sample PS. In the job color adjustment, an input profile is generated for color conversion of the color values of document data included in the job into the color values of a device-independent color space (e.g., L*a*b values or XYZ values). In the device color adjustment, an output profile is generated for color conversion from a device-independent color space into a color space for the image forming apparatus 10 to print the document data. The input profile or the output profile may be simply referred to as the profile where the distinction therebetween is unnecessary.

The color adjustment system 20 is a system, such as a personal computer (PC) or a workstation, that performs color adjustment with the read data read by the image reading apparatus 30 from the print sample PS of the job or the color chart CC printed by the image forming apparatus 10. The color adjustment system 20 further manages the document data printed by the image forming apparatus 10. The color adjustment system 20 may be implemented by a single information processing apparatus or a system including a plurality of information processing apparatuses.

Specifically, the color adjustment system 20 generates the input profile by performing the job color adjustment with the read data read by the image reading apparatus 30 from the print sample PS of the job, and transmits the generated input profile to the image forming apparatus 10. The color adjustment system 20 further generates the output profile by performing the device color adjustment with the read data read by the image reading apparatus 30 from the color chart CC printed by the image forming apparatus 10, and transmits the generated output profile to the image forming apparatus 10. Then, the image forming apparatus 10 prints the document data with the received input profile and output profile.

The image reading apparatus 30 is an apparatus that performs a reading process on the print sample PS or the color chart CC printed by the image forming apparatus 10 to generate read data represented by colorimetric values such as L*a*b values, XYZ values, or RGB values. The image reading apparatus 30 transmits the read data to the color adjustment system 20. The image reading apparatus 30 may be an image scanner or a colorimeter, for example. The image reading apparatus 30, however, is not limited thereto, and may be any device or apparatus capable of acquiring the read data of the print sample PS and the color chart CC. It is assumed in the following description that the colorimetric values obtained from the reading process by the image reading apparatus 30 are the L*a*b values of the L*a*b color system (hereinafter simply referred to as the Lab values). However, the read data read by the image reading apparatus 30 are not limited to the colorimetric values such as the Lab values. For example, the image reading apparatus 30 may transmit the read data to the color adjustment system 20 as raw data, and the color adjustment system 20 may convert the raw data into the colorimetric values.

The image reading apparatus 30 further performs a reading process on a reproduced image print RIP, which is a printed material printed by the image forming apparatus 10 based on the document data of the job corresponding to the print sample PS. Read data of the reproduced image print RIP is used in the job color adjustment by the color adjustment system 20.

The color adjustment assistance system 40 is a system that collects information such as the profiles generated by the color adjustment system 20, the read data of the print sample PS, the reproduced image print RIP, and the color chart CC read by the image reading apparatus 30, the document data printed by the image forming apparatus 10, a history of operations performed on the image forming apparatus 10 and the color adjustment system 20, a history of color adjustments performed by the color adjustment system 20, and information of the image forming apparatus 10 on which the color adjustment is performed (i.e., target device information). These types of information will be referred to as the second information (hereinafter occasionally referred to as the adjustment-related information). In response to receipt of a request for assistance from the color adjustment system 20, the color adjustment assistance system 40 transmits to the color adjustment system 20 a response to the request created via the service provider terminal 60 based on the adjustment-related information. The color adjustment assistance system 40 may be implemented by a single information processing apparatus or a system including a plurality of information processing apparatuses.

The device management system 50 is a system that collects information such as the operating status of the image forming apparatus 10, a history of errors occurred in the image forming apparatus 10, and print settings information of the document data and the color chart CC. These types of information will be referred to as the first information (hereinafter occasionally referred to as the device-related information). In response to receipt of a request from the color adjustment assistance system 40, the device management system 50 provides the device-related information to the color adjustment assistance system 40. The device management system 50 may be implemented by a single information processing apparatus or a system including a plurality of information processing apparatuses.

The color adjustment assistance system 40 and the device management system 50 described above form a system implemented on a cloud platform (i.e., a could system). The could system is managed by a service provider of a service of providing a response such as guidance to a request for assistance with color adjustment from the color adjustment system 20. The color adjustment assistance system 40 and the device management system 50 may be different systems or the same system. The color adjustment system 20 is an example of a first system. The cloud system including the color adjustment assistance system 40 and/or the device management system 50 is an example of a second system.

The service provider terminal 60 is an information terminal for the service provider with expertise in color adjustment to input the response based on the adjustment-related information and the device-related information provided by the color adjustment assistance system 40 in response to the request for assistance from the color adjustment system 20 notified via the color adjustment assistance system 40.

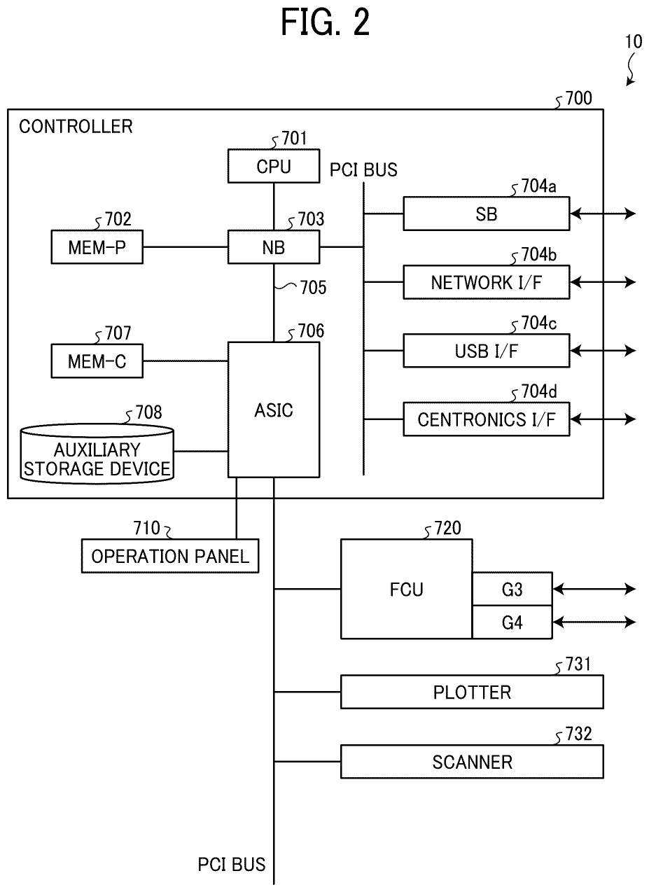

FIG. 2 is a diagram illustrating an exemplary hardware configuration of the image forming apparatus 10 of the embodiment. A hardware configuration of the image forming apparatus 10 of the embodiment will be described with reference to FIG. 2. It is assumed in the following description that the image forming apparatus 10 in FIG. 2 is an MFP. Even if the image forming apparatus 10 is a commercial printing machine or an electrophotographic or inkjet printer equipped with the printer function as a major function thereof, a basic configuration of the image forming apparatus 10 is similar to the configuration illustrated in FIG. 2.

As illustrated in FIG. 2, the image forming apparatus 10 of the embodiment includes a controller 700, an operation panel 710 (an operation display device), a facsimile control unit (FCU) 720, a plotter 731 (a printer), and a scanner 732, which are connected to each other by peripheral component interface (PCI) buses.

The controller 700 is a device that performs overall control of the image forming apparatus 10 and controls rendering, communication, and input from the operation panel 710.

The operation panel 710, such a touch panel, for example, is a device with an input function to receive inputs to the controller 700 and a display function to display the status of the image forming apparatus 10, for example. The operation panel 710 is directly connected to a later-described application specific integrated circuit (ASIC) 706.

The FCU 720, which is a device that implements the FAX function, is connected to the ASIC 706 by a PCI bus, for example. The FCU 720 is capable of performing wireless communication with third generation (G3) or fourth generation (G4) technology, for example, as well as wired communication.

The plotter 731, which is a device that implements the printer function, is connected to the ASIC 706 by a PCI bus, for example. The scanner 732, which is a device that implements the scanner function, is connected to the ASIC 706 by a PCI bus, for example.

The controller 700 includes a central processing unit (CPU) 701, a system memory (MEM-P) 702, a north bridge (NB) 703, a south bridge (SB) 704a, a network interface (I/F) 704b, a universal serial bus (USB) I/F 704c, a Centronics I/F 704d, the ASIC 706, a local memory (MEM-C) 707, and an auxiliary storage device 708.

The CPU 701 performs overall control of the image forming apparatus 10. The CPU 701 is connected to a chipset including the MEM-P 702, the NB 703, and the SB 704a. The CPU 701 is connected to another device via the chipset.

The MEM-P 702 is a memory used to store or deploy programs and data or used as a rendering memory of the printer, for example. The MEM-P 702 includes a read only memory (ROM) and a random access memory (RAM). The ROM is a read only memory used to store programs and data. The RAM is a writable and readable memory used to deploy programs and data or used as a rendering memory of the printer, for example.

The NB 703 is a bridge for connecting the CPU 701, the MEM-P 702, the SB 704a, and an accelerated graphics port (AGP) bus 705 to each other. The NB 703 includes a memory controller that controls the writing and reading to and from the MEM-P 702, a PCI master, and an AGP target.

The SB 704a is a bridge for connecting the NB 703 to a PCI device and a peripheral device. The SB 704a is connected to the NB 703 via a PCI bus, which is connected to the network I/F 704b, the USB I/F 704c, and the Centronics I/F 704d, for example.

The network I/F 704b is an interface for performing data communication with an external device such as the color adjustment system 20 via the network N. The network I/F 704b is compatible with Ethernet® and enables communication conforming to transmission control protocol/internet protocol (TCP/IP), for example. The network I/F 704b may be an interface for wireless communication conforming to wireless fidelity (Wi-Fi®), for example.

The USB I/F 704c is an interface enabling communication with a device conforming to the USB standard.

The Centronics I/F 704d is an interface with the specifications of a parallel port capable of transmitting multiple bits.

The AGP bus 705 is a bus interface for a graphics accelerator card proposed to speed up graphics processing. The AGP bus 705 enables the graphics accelerator card to directly access the MEM-P 702 with a high throughput, thereby implementing a high-speed graphics accelerator card.

The ASIC 706, which is an integrated circuit (IC) for image processing, includes hardware components for image processing. The ASIC 706 functions as a bridge for connecting the AGP bus 705, the PCI bus, the auxiliary storage device 708, and the MEM-C 707 to each other. The ASIC 706 includes a PCI target, an AGP master, an arbiter (ARB) as a core component of the ASIC 706, a memory controller that controls the MEM-C 707, a plurality of direct memory access controllers (DMACs) that perform processes such as the rotation of image data with a hardware logic, and a PCI unit that transfers data to and from the plotter 731 or the scanner 732 via the PCI bus. The ASIC 706 is connected to the FCU 720, the plotter 731, and the scanner 732 via the PCI bus, for example. The ASIC 706 is also connected to a host PC and a network, for example.

The MEM-C 707 is a memory used as a copy image buffer or a code buffer.

The auxiliary storage device 708 is a storage device, such as a hard disk drive (HDD), a solid state drive (SSD), a secure digital (SD) card, or a flash memory, for storing image data, programs, font data, and forms, for example.

The above-described programs of the image forming apparatus 10 may be distributed as recorded on a computer readable recording medium (e.g., the auxiliary storage device 708) in a file in an installable or executable format.

The hardware configuration of the image forming apparatus 10 illustrated in FIG. 2 is illustrative. The image forming apparatus 10 is not necessarily required to include all of the component devices illustrated in FIG. 2. Further, the image forming apparatus 10 may include a component device other than those illustrated in FIG. 2.

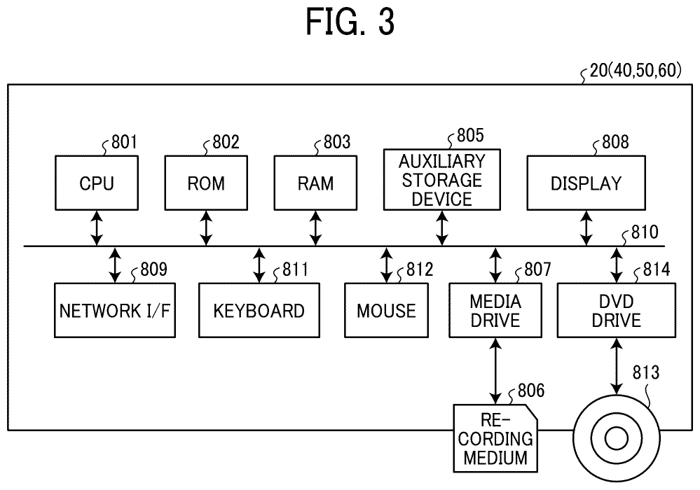

FIG. 3 is a diagram illustrating an exemplary hardware configuration of the color adjustment system 20 or another system or terminal of the embodiment. A hardware configuration of the color adjustment system 20 of the embodiment will be described with reference to FIG. 3. The color adjustment assistance system 40, the device management system 50, and the service provider terminal 60 have a hardware configuration similar to that illustrated in FIG. 3.

As illustrated in FIG. 3, the color adjustment system 20 includes a CPU 801, a ROM 802, a RAM 803, an auxiliary storage device 805, a media drive 807, a display 808, a network I/F 809, a keyboard 811, a mouse 812, and a digital versatile disc (DVD) drive 814.

The CPU 801 is an arithmetic device that controls overall operation of the color adjustment system 20. The ROM 802 is a nonvolatile storage device that stores programs for the color adjustment system 20. The RAM 803 is a volatile storage device used as a work area of the CPU 801.

The auxiliary storage device 805 is a storage device, such as an HDD or an SSD, that stores various data and programs, for example. The media drive 807 is a device that controls data writing and reading to and from a recording medium 806 such as a flash memory under the control of the CPU 801.

The display 808 is a display device with liquid crystals or organic electroluminescence (EL) elements, for example. The display 808 displays various information such as a cursor, menus, windows, text, and images.

The network I/F 809 is an interface for performing data communication with the image forming apparatus 10 or the image reading apparatus 30, for example, via an internal network of the printing company (e.g., a local area network (LAN)), and for performing data communication with the color adjustment assistance system 40 or the device management system 50, for example, via the network N. For example, the network I/F 809 is a network interface card (NIC) compatible with Ethernet® and enabling communication conforming to TCP/IP, for example. The network I/F 809 may be an interface for wireless communication conforming to Wi-Fi®, for example. The interface for the internal network and the interface for the network N described above may be configured separately.

The keyboard 811 is an input device for selecting characters, numbers, and various instructions and moving the cursor, for example. The mouse 812 is an input device for selecting and executing various instructions, selecting a processing target, and moving the cursor, for example.

The DVD drive 814 is a device that controls data writing and reading to and from a DVD 813, such as a DVD-ROM or DVD-recordable (DVD-R), as an example of a removable storage medium.

The CPU 801, the ROM 802, the RAM 803, the auxiliary storage device 805, the media drive 807, the display 808, the network I/F 809, the keyboard 811, the mouse 812, and the DVD drive 814 are communicably connected to each other by a bus 810 including address buses and data buses.

The hardware configuration of the color adjustment system 20 illustrated in FIG. 3 is illustrative. The color adjustment system 20 is not necessary required to include all of the components illustrated in FIG. 3. Further, the color adjustment system 20 may include a component other than those illustrated in FIG. 3.

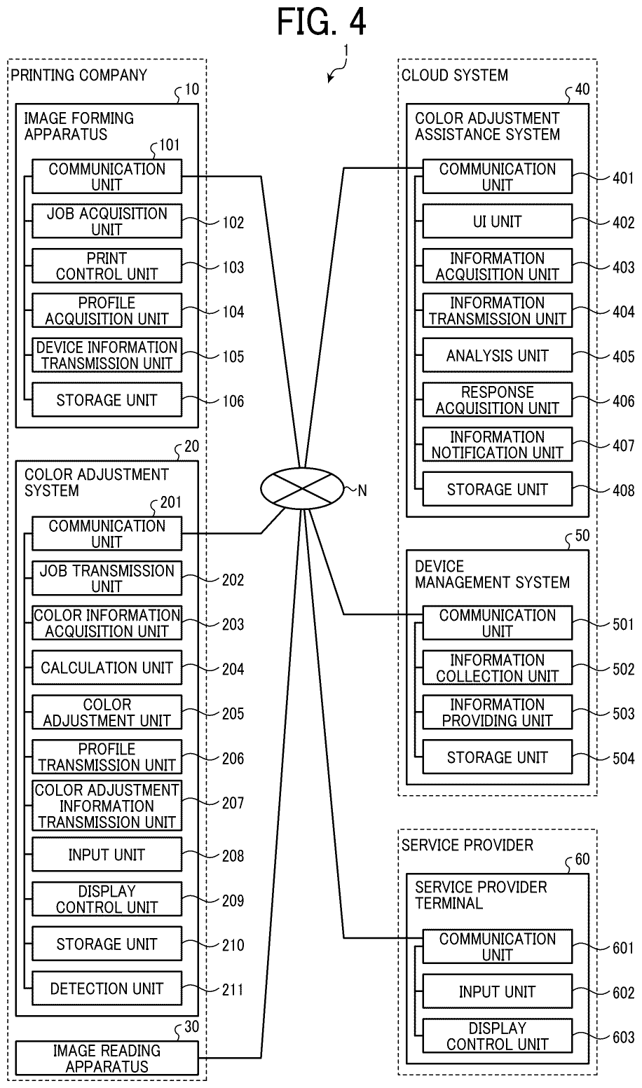

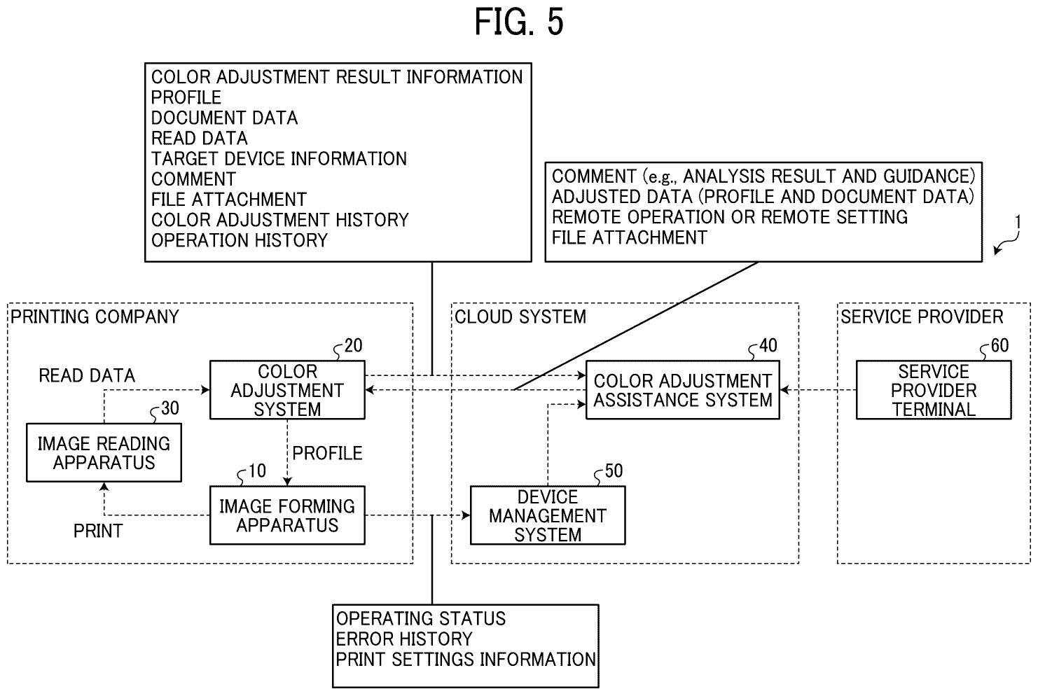

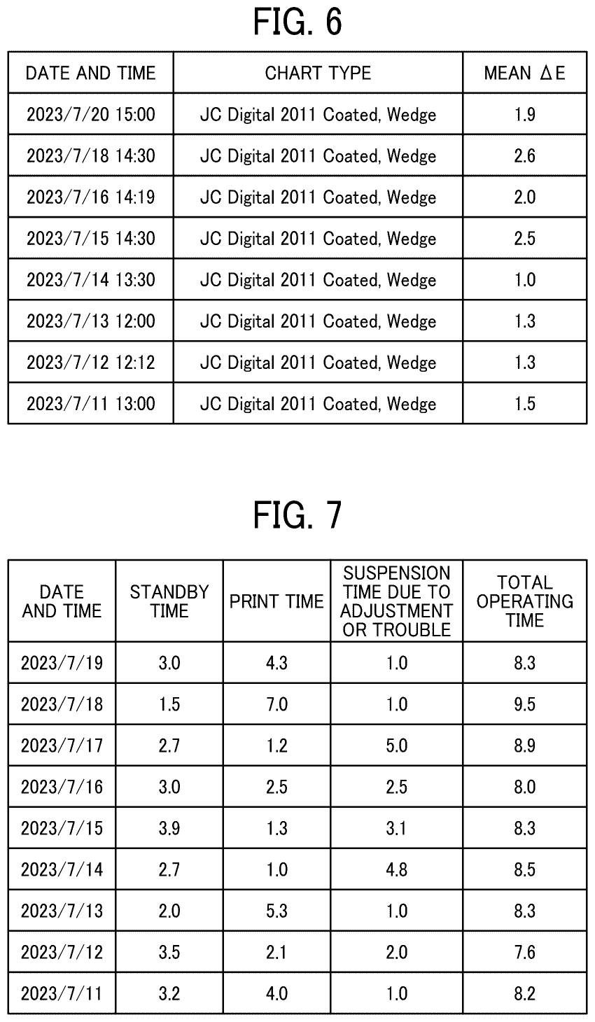

FIG. 4 is a diagram illustrating an exemplary configuration of functional blocks of the information processing system 1 of the embodiment. FIG. 5 is a diagram illustrating an overview of the operation of the information processing system 1 of the embodiment. FIG. 6 is a table illustrating an example of color adjustment history information of the embodiment. FIG. 7 is a table illustrating an example of operation history information of the embodiment. A configuration and operation of the functional blocks of the information processing system 1 of the embodiment will be described with reference to FIGS. 4 to 7.

As illustrated in FIG. 4, the image forming apparatus 10 includes a communication unit 101, a job acquisition unit 102, a print control unit 103, a profile acquisition unit 104, a device information transmission unit 105, and a storage unit 106.

The communication unit 101 is a functional unit that performs data communication with the color adjustment system 20 or the device management system 50. The communication unit 101 is implemented by the network I/F 704b and a program executed by the CPU 701 illustrated in FIG. 2.

The job acquisition unit 102 is a functional unit that acquires the print job of the document data or the color chart CC from the color adjustment system 20. The job acquisition unit 102 further acquires a regular print job from an external device via the network N. The job acquisition unit 102 is implemented by a program executed by the CPU 701 illustrated in FIG. 2, for example.

The print control unit 103 is a functional unit that, based on the print job of the document data acquired by the job acquisition unit 102, causes the plotter 731 to print the document data as a reproduced image print by applying the profiles generated by the color adjustment system 20 to the printing. The print control unit 103 further causes the plotter 731 to print the color chart CC based on the print job of the color chart CC acquired by the job acquisition unit 102.

The print control unit 103 further stores a history of operating statuses of the image forming apparatus 10 in the storage unit 106 as the operation history information illustrated in FIG. 7. The operation history information is part of the device-related information described above. The operation history information illustrated in FIG. 7 as an example is history information in which the standby time, the print time, the suspension time due to the color adjustment or trouble, and the total operating time of the image forming apparatus 10 are associated with each other.

The print control unit 103 is implemented by a program executed by the CPU 701 illustrated in FIG. 2, for example.

The profile acquisition unit 104 is a functional unit that acquires, via the communication unit 101, the input profile and the output profile generated through the color adjustment by the color adjustment system 20. The profile acquisition unit 104 stores (i.e., registers) the acquired profiles in the storage unit 106. The profiles stored in the storage unit 106 are applied to the control of print output to a sheet by the print control unit 103. The profile acquisition unit 104 is implemented by a program executed by the CPU 701 illustrated in FIG. 2, for example.

The device information transmission unit 105 is a functional unit that collects the device-related information of the image forming apparatus 10 and transmits the collected device-related information to the device management system 50 via the communication unit 101, as illustrated in FIG. 5. The device information transmission unit 105 is implemented by a program executed by the CPU 701 illustrated in FIG. 2, for example.

The storage unit 106 is a functional unit that stores the profiles acquired by the profile acquisition unit 104, the device-related information, and various data and programs, for example. The storage unit 106 is implemented by the auxiliary storage device 708 illustrated in FIG. 2.

Any of the functional units of the image forming apparatus 10 in FIG. 4 implemented by software (i.e., programs) may be at least partially implemented by a hardware circuit such as a field programmable gate array (FPGA) or ASIC.

The functional units of the image forming apparatus 10 illustrated in FIG. 4 are conceptual representation of functions, and are not limited to the configuration illustrated in FIG. 4. For example, a plurality of functional units illustrated in FIG. 4 as separate functional units of the image forming apparatus 10 may be configured as a single functional unit. Further, the function of any of the functional units of the image forming apparatus 10 illustrated in FIG. 4 may be divided into a plurality of functions to form a plurality of functional units. Further, the functional units of the image forming apparatus 10 are not necessarily required to be configured as distinct software modules such as the blocks illustrated in FIG. 4. For example, the functions of the functional units may be implemented as a whole by a program executed on the image forming apparatus 10.

As illustrated in FIG. 4, the color adjustment system 20 includes a communication unit 201, a job transmission unit 202, a color information acquisition unit 203, a calculation unit 204, a color adjustment unit 205, a profile transmission unit 206, a color adjustment information transmission unit 207 (an example of a transmission unit), an input unit 208, a display control unit 209 (an example of a second display control unit), a storage unit 210, and a detection unit 211.

The communication unit 201 is a functional unit that performs data communication with the image forming apparatus 10, the image reading apparatus 30, or the color adjustment assistance system 40. The communication unit 201 is implemented by the network I/F 809 and a program executed by the CPU 801 illustrated in FIG. 3.

The job transmission unit 202 is a functional unit that transmits the print job of the document data or the color chart CC to the image forming apparatus 10 via the communication unit 201 to print the document data or the color chart CC from the image forming apparatus 10. The job transmission unit 202 is implemented by a program executed by the CPU 801 illustrated in FIG. 3, for example.

The color information acquisition unit 203 is a functional unit that acquires the read data from the image reading apparatus 30 via the communication unit 201, as illustrated in FIG. 5. The read data is obtained through the reading process by the image reading apparatus 30 to read the print sample PS or the reproduced image print RIP or the color chart CC printed by the image forming apparatus 10, and is represented by the colorimetric values (e.g., the Lab values). The color information acquisition unit 203 is implemented by a program executed by the CPU 801 illustrated in FIG. 3, for example.

The calculation unit 204 is a functional unit that generates a color difference map in the job color adjustment by calculating a color difference ΔE between the image of the print sample PS and the reproduced image obtained after color matching. For example, for each of the pixel values of the pixels in the image of the print sample PS, the calculation unit 204 calculates the color difference ΔE from the pixel value of the corresponding pixel in the reproduced image. Herein, the image of the print sample PS refers to the image displayed based on the read data of the print sample PS, and the reproduced image refers to the image displayed based on the read data of the reproduced image print RIP. Further, the color difference map refers to a map displayed with monochrome tone changed in accordance with the value of the color difference ΔE, for example. The calculation unit 204 further generates a color difference map in the job color adjustment by calculating the color difference ΔE between the image of the print sample PS and the reproduced image obtained before the color matching. The calculation unit 204 also calculates the mean value of the thus-calculated color differences ΔE, i.e., the mean color difference ΔE. The color difference ΔE before the color matching and the color difference ΔE after the color matching may be referred to as the pre-adjustment ΔE and the post-adjustment ΔE, respectively.

In the device color adjustment, the calculation unit 204 further calculates the mean value of the color differences ΔE (the mean ΔE) and the maximum color difference ΔE (the maximum ΔE) for each color adjustment patch based on the read data of the color chart CC.

The calculation unit 204 is implemented by a program executed by the CPU 801 illustrated in FIG. 3, for example.

The color adjustment unit 205 is a functional unit that generates the input profile in the job color adjustment by performing an adjustment to make the color of the reproduced image match the color of the image of the print sample PS. The color adjustment unit 205 further generates the output profile in the device color adjustment by performing a commonly used color adjustment process to make the colorimetric values of printed color adjustment patches reproduce the already known color values of color adjustment patches on the color chart CC. The color adjustment unit 205 is implemented by a program executed by the CPU 801 illustrated in FIG. 3, for example.

The calculation unit 204 and the color adjustment unit 205 store the result of job color adjustment and the result of device color adjustment in the storage unit 210 as the color adjustment history information illustrated in FIG. 6. The color adjustment history information is part of the adjustment-related information described above. The color adjustment history information illustrated in FIG. 6 as an example is history information of the device color adjustment, in which the date and time when the mean ΔE is calculated by the calculation unit 204, the type of the color chart CC used in the device color adjustment (the chart type), and the mean ΔE calculated by the calculation unit 204 are associated with each other.

The profile transmission unit 206 is a functional unit that transmits the profiles generated by the color adjustment unit 205 to the image forming apparatus 10 via the communication unit 201, as illustrated in FIG. 5. The profile transmission unit 206 is implemented by a program executed by the CPU 801 illustrated in FIG. 3, for example.

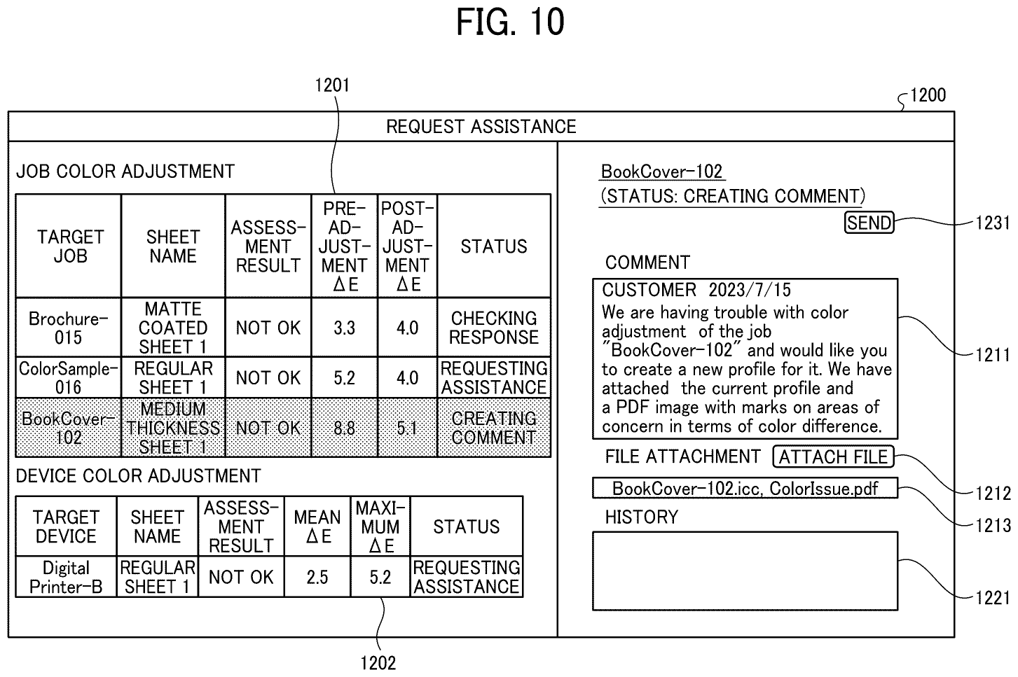

The color adjustment information transmission unit 207 is a functional unit that collects the adjustment-related information related to the job color adjustment and the device color adjustment performed on the image forming apparatus 10, and transmits the collected adjustment-related information to the color adjustment assistance system 40 via the communication unit 201, as illustrated in FIG. 5. For example, if the detection unit 211 detects the occurrence of an issue related to the job color adjustment or the device color adjustment, or if a user (i.e., the printing company) performs an assistance request operation on a later-described assistance request screen 1200 illustrated in FIG. 10, the color adjustment information transmission unit 207 transmits the adjustment-related information to the color adjustment assistance system 40 via the communication unit 201 together with a message of request for assistance. The color adjustment information transmission unit 207 is implemented by a program executed by the CPU 801 illustrated in FIG. 3, for example.

The input unit 208 is a functional unit that receives input of an operation performed on a later-described device color adjustment result screen 1000, for example, by the user (i.e., the printing company). The input unit 208 is implemented by the keyboard 811 and the mouse 812 illustrated in FIG. 3.

The display control unit 209 is a functional unit that controls the display of various screens (e.g., the device color adjustment result screen 1000) and information on the display 808 of the color adjustment system 20 (an example of a second display device). The display control unit 209 is implemented by a program executed by the CPU 801 illustrated in FIG. 3, for example.

The storage unit 210 is a functional unit that stores the adjustment-related information such as the document data, the data of the color chart CC, and the profiles generated by the color adjustment unit 205. The storage unit 210 is implemented by the auxiliary storage device 805 illustrated in FIG. 3.

The detection unit 211 is a functional unit that detects whether the job color adjustment or the device color adjustment is assessed as “NOT OK” a particular number of times consecutively. For example, the job color adjustment is assessed as “NOT OK” if the post-adjustment ΔE calculated by the calculation unit 204 is equal to or greater than a particular value, and the device color adjustment is assessed as “NOT OK” if at least one of the mean ΔE or the maximum ΔE calculated by the calculation unit 204 is equal to or greater than a particular value. However, the detection unit 211 is not limited to detecting whether the job color adjustment or the device color adjustment is assessed as “NOT OK” the particular number of times consecutively, as described above. For example, the detection unit 211 may detect the occurrence of the issue related to the job color adjustment or the device color adjustment when it is determined that a particular condition is met. The particular condition may be that the color adjustment is assessed as “NOT OK” at a certain rate out of a particular number of executions of the color adjustment, or that the color difference ΔE calculated through the color adjustment has an unexpected abnormal value, for example.

Any of the functional units of the color adjustment system 20 in FIG. 4 implemented by software (i.e., programs) may be at least partially implemented by a hardware circuit such as an FPGA or ASIC.

The functional units of the color adjustment system 20 illustrated in FIG. 4 are conceptual representation of functions, and are not limited to the configuration illustrated in FIG. 4. For example, a plurality of functional units illustrated in FIG. 4 as separate functional units of the color adjustment system 20 may be configured as a single functional unit. Further, the function of any of the functional units of the color adjustment system 20 illustrated in FIG. 4 may be divided into a plurality of functions to form a plurality of functional units. Further, the functional units of the color adjustment system 20 are not necessarily required to be configured as distinct software modules such as the blocks illustrated in FIG. 4. For example, the functions of the functional units may be implemented as a whole by a program executed on the color adjustment system 20.

In the above description, the user (i.e., the printing company) inputs an operation on a screen such as the device color adjustment result screen 1000 displayed by the display control unit 209 of the color adjustment system 20 with the input unit 208 of the color adjustment system 20. However, the input of the operation is not limited thereto. For example, a screen such as the device color adjustment result screen 1000 may be displayed on an information terminal used by the user (i.e., the printing company) and capable of performing data communication with the color adjustment system 20, and the operation may be input on the screen via the information terminal.

As illustrated in FIG. 4, the color adjustment assistance system 40 includes a communication unit 401, a user interface (UI) unit 402 (an example of a first display control unit), an information acquisition unit 403 (an example of an acquisition unit), an information transmission unit 404, an analysis unit 405, a response acquisition unit 406, an information notification unit 407 (an example of a notification unit), and a storage unit 408.

The communication unit 401 is a functional unit that performs data communication with the color adjustment system 20, the device management system 50, or the service provider terminal 60. The communication unit 401 is implemented by the network I/F 809 and a program executed by the CPU 801 illustrated in FIG. 3.

The UI unit 402 is a functional unit that provides screen information for the printing company (i.e., the user) to the color adjustment system 20 via the communication unit 401, and provides screen information for the service provider to the service provider terminal 60 via the communication unit 401. Details of screens provided by the UI unit 402 will be described later. The UI unit 402 is implemented by a program executed by the CPU 801 illustrated in FIG. 3, for example.

The information acquisition unit 403 is a functional unit that acquires the adjustment-related information from the color adjustment system 20 via the communication unit 401, and acquires the device-related information from the device management system 50 via the communication unit 401. For example, the information acquisition unit 403 acquires the adjustment-related information from the color adjustment system 20 periodically or when the request for assistance is received from the color adjustment system 20. The information acquisition unit 403 is implemented by a program executed by the CPU 801 illustrated in FIG. 3, for example.

The information transmission unit 404 is a functional unit that transmits the adjustment-related information and the device-related information acquired by the information acquisition unit 403 to the color adjustment system 20 or the service provider terminal 60 via the communication unit 401. The information transmission unit 404 is implemented by a program executed by the CPU 801 illustrated in FIG. 3, for example.

The analysis unit 405 is a functional unit that analyses the issue in the color adjustment with the adjustment-related information and the device-related information acquired by the information acquisition unit 403. For example, the analysis unit 405 automatically generates a comment describing an analysis result based on the color adjustment history of the adjustment-related information, and automatically generates a comment describing a draft of the response to the user (i.e., the printing company) based on the analysis result. The analysis unit 405 is implemented by a program executed by the CPU 801 illustrated in FIG. 3, for example.

The response acquisition unit 406 is a functional unit that acquires, via the communication unit 401, at least one of a comment or a file attachment such as a profile created and adjusted by the service provider or document data as the response to the request for assistance returned by the service provider via the service provider terminal 60, as illustrated in FIG. 5. Further, the response acquisition unit 406 may cooperate with the information notification unit 407 to perform a remote operation or remote setting on the image forming apparatus 10 or the color adjustment system 20 as the response from the service provider via the service provider terminal 60, as illustrated in FIG. 5. If there is an issue in the print settings, for example, the remote operation or remote setting allows the service provider to directly handle the issue. The response acquisition unit 406 is implemented by a program executed by the CPU 801 illustrated in FIG. 3, for example.

The information notification unit 407 is a functional unit that notifies the color adjustment system 20 of the response acquired by the response acquisition unit 406 via the communication unit 401. The information notification unit 407 is implemented by a program executed by the CPU 801 illustrated in FIG. 3, for example.

The storage unit 408 is a functional unit that stores the adjustment-related information and the device-related information acquired by the information acquisition unit 403 and the response acquired by the response acquisition unit 406, for example. That is, the adjustment-related information acquired from the color adjustment system 20 and the device-related information acquired from the device management system 50 are stored together in the storage unit 408. Then, information based on the above-described information is displayed on a screen of the color adjustment system 20 and a screen of the service provider terminal 60, as described later, enabling the user (i.e., the printing company) and the service provider to share the information. With the above-described information stored together in the storage unit 408, a knowledge base is formed which is usable to solve issues in future. The storage unit 408 is implemented by the auxiliary storage device 805 illustrated in FIG. 3.

Any of the functional units of the color adjustment assistance system 40 in FIG. 4 implemented by software (i.e., programs) may be at least partially implemented by a hardware circuit such as an FPGA or ASIC.

The functional units of the color adjustment assistance system 40 illustrated in FIG. 4 are conceptual representation of functions, and are not limited to the configuration illustrated in FIG. 4. For example, a plurality of functional units illustrated in FIG. 4 as separate functional units of the color adjustment assistance system 40 may be configured as a single functional unit. Further, the function of any of the functional units of the color adjustment assistance system 40 illustrated in FIG. 4 may be divided into a plurality of functions to form a plurality of functional units. Further, the functional units of the color adjustment assistance system 40 are not necessarily required to be configured as distinct software modules such as the blocks illustrated in FIG. 4. For example, the functions of the functional units may be implemented as a whole by a program executed on the color adjustment assistance system 40.

As illustrated in FIG. 4, the device management system 50 includes a communication unit 501, an information collection unit 502, an information providing unit 503, and a storage unit 504.

The communication unit 501 is a functional unit that performs data communication with the image forming apparatus 10 or the color adjustment assistance system 40. The communication unit 501 is implemented by the network I/F 809 and a program executed by the CPU 801 illustrated in FIG. 3.

The information collection unit 502 is a functional unit that collects the device-related information periodically, for example, from the image forming apparatus 10 via the communication unit 501. The information collection unit 502 is implemented by a program executed by the CPU 801 illustrated in FIG. 3, for example.

The information providing unit 503 is a functional unit that provides the device-related information of the image forming apparatus 10 represented by the target device information to the color adjustment assistance system 40 via the communication unit 501 in response to a request from the color adjustment assistance system 40. The information providing unit 503 is implemented by a program executed by the CPU 801 illustrated in FIG. 3, for example.

The storage unit 504 is a functional unit that stores the device-related information collected by the information collection unit 502, for example. The storage unit 504 is implemented by the auxiliary storage device 805 illustrated in FIG. 3.

Any of the functional units of the color adjustment assistance system 40 in FIG. 4 implemented by software (i.e., programs) may be at least partially implemented by a hardware circuit such as an FPGA or ASIC.

The functional units of the device management system 50 illustrated in FIG. 4 are conceptual representation of functions, and are not limited to the configuration illustrated in FIG. 4. For example, a plurality of functional units illustrated in FIG. 4 as separate functional units of the device management system 50 may be configured as a single functional unit. Further, the function of any of the functional units of the device management system 50 illustrated in FIG. 4 may be divided into a plurality of functions to form a plurality of functional units. Further, the functional units of the device management system 50 are not necessarily required to be configured as distinct software modules such as the blocks illustrated in FIG. 4. For example, the functions of the functional units may be implemented as a whole by a program executed on the device management system 50.

As illustrated in FIG. 4, the service provider terminal 60 includes a communication unit 601, an input unit 602, and a display control unit 603 (an example of the first display control unit).

The communication unit 601 is a functional unit that performs data communication with the color adjustment assistance system 40. The communication unit 601 is implemented by the network I/F 809 and a program executed by the CPU 801 illustrated in FIG. 3.

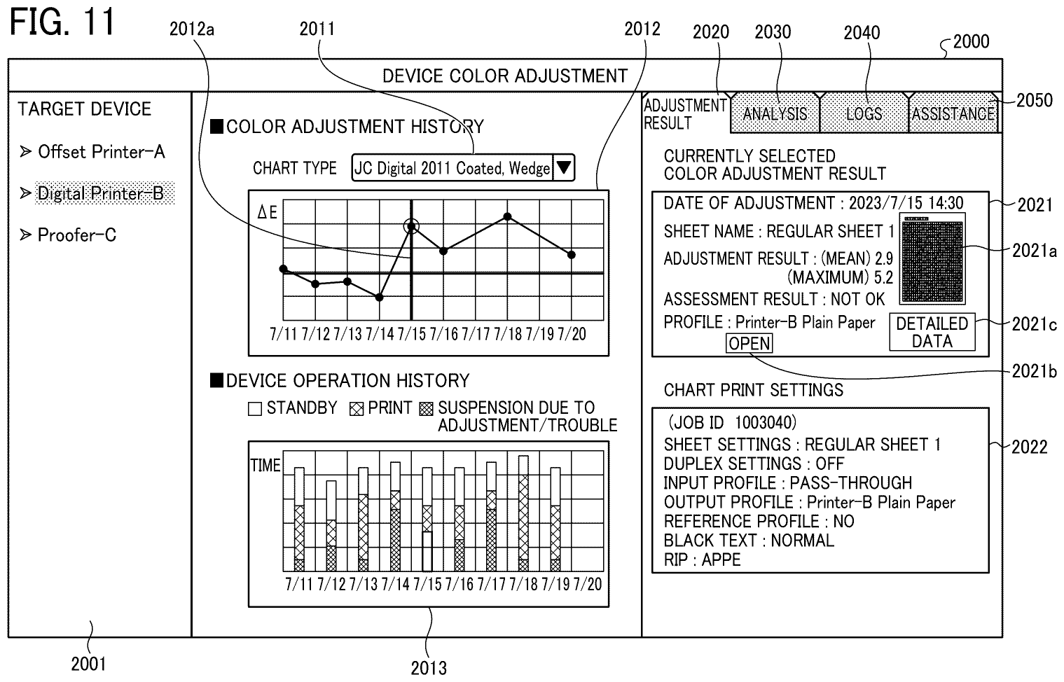

The input unit 602 is a functional unit for the service provider to input the response to the request for assistance, for example, on a screen such as a later-described device color adjustment assistance screen 2000 illustrated in FIG. 11. The input unit 602 is implemented by the keyboard 811 and the mouse 812 illustrated in FIG. 3.

The display control unit 603 is a functional unit that controls the display of various screens (e.g., the device color adjustment assistance screen 2000) and information on the display 808 of the service provider terminal 60 (an example of a first display device). The display control unit 603 is implemented by a program executed by the CPU 801 illustrated in FIG. 3, for example.

Any of the functional units of the service provider terminal 60 in FIG. 4 implemented by software (i.e., programs) may be at least partially implemented by a hardware circuit such as an FPGA or ASIC.

The functional units of the service provider terminal 60 illustrated in FIG. 4 are conceptual representation of functions, and are not limited to the configuration illustrated in FIG. 4. For example, a plurality of functional units illustrated in FIG. 4 as separate functional units of the service provider terminal 60 may be configured as a single functional unit. Further, the function of any of the functional units of the service provider terminal 60 illustrated in FIG. 4 may be divided into a plurality of functions to form a plurality of functional units. Further, the functional units of the service provider terminal 60 are not necessarily required to be configured as distinct software modules such as the blocks illustrated in FIG. 4. For example, the functions of the functional units may be implemented as a whole by a program executed on the service provider terminal 60.

The functional units included in the image forming apparatus 10, the color adjustment system 20, the color adjustment assistance system 40, the device management system 50, or the service provider terminal 60 in FIG. 4 are not necessarily required to be included therein, and may be included in a different device.

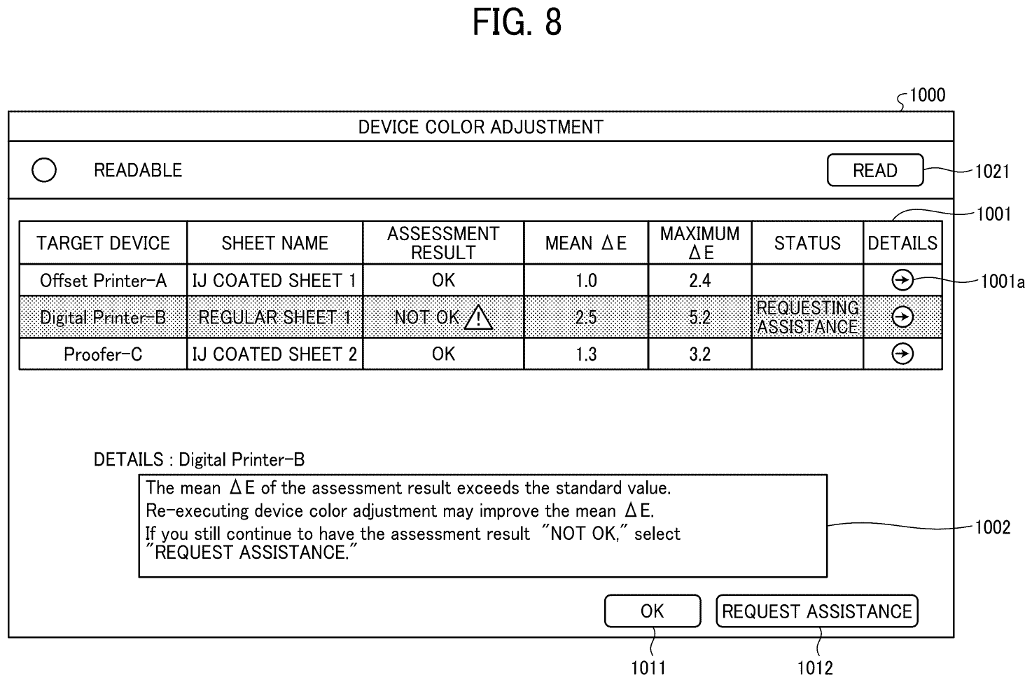

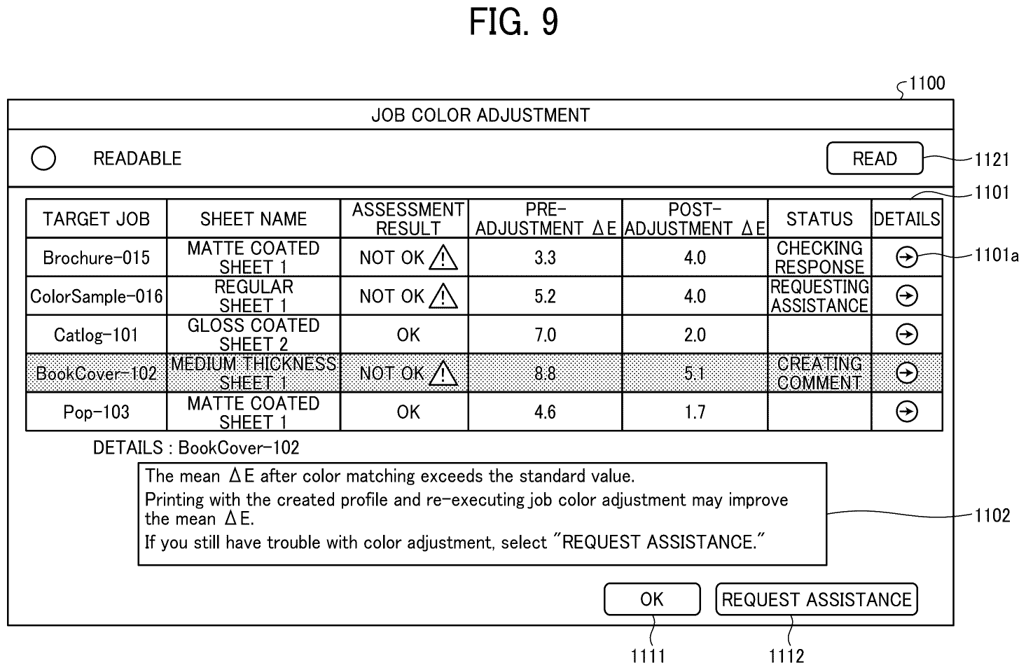

FIG. 8 is a diagram illustrating an example of a device color adjustment result screen displayed on a terminal of the printing company (i.e., the color adjustment system 20). FIG. 9 is a diagram illustrating an example of a job color adjustment result screen displayed on the terminal of the printing company. FIG. 10 is a diagram illustrating an example of an assistance request screen displayed on the terminal of the printing company. Screens displayed on the terminal of the printing company in the information processing system 1 of the embodiment will be described with reference to FIGS. 8 to 10.

The printing company as the user performs an operation of displaying the device color adjustment result screen 1000 as illustrated in FIG. 8 via the input unit 208 of the color adjustment system 20. Then, the display control unit 209 transmits a request to display the device color adjustment result screen 1000 to the color adjustment assistance system 40 via the communication unit 201. In response to the display request, the UI unit 402 of the color adjustment assistance system 40 transmits screen information of the device color adjustment result screen 1000 to the color adjustment system 20 via the communication unit 401. Along with the transmission of the screen information by the UI unit 402, the information transmission unit 404 transmits to the color adjustment system 20 the adjustment-related information and the device-related information to be used to display the device color adjustment result screen 1000. Then, the display control unit 209 causes the display 808 to display the device color adjustment result screen 1000.

The device color adjustment result screen 1000 is a screen for displaying a history of assessment results of the device color adjustment performed by the color adjustment system 20. As illustrated in FIG. 8, the device color adjustment result screen 1000 includes a color adjustment result display field 1001, a details display field 1002, an OK button 1011, a request assistance button 1012, and a read button 1021.

The color adjustment result display field 1001 is a field for displaying the assessment result of the device color adjustment for each target device (i.e., the image forming apparatus 10). In the example illustrated in FIG. 8, the target device (i.e., the image forming apparatus 10), the sheet name, the assessment result, the mean ΔE, the maximum ΔE, and the status are displayed in association with each other in the color adjustment result display field 1001. In the color adjustment result display field 1001, a details column includes a details button 1001a for each target device. If the details button 1001a is pressed, the display control unit 209 brings the row of the corresponding target device into the selected state, and displays details of the assessment result in the details display field 1002. The status includes “CREATING COMMENT,” “REQUESTING ASSISTANCE,” and “CHECKING RESPONSE,” for example. The status “CREATING COMMENT” indicates that a comment such as a question to the service provider about the assessment result “NOT OK” of the device color adjustment is being created. The status “REQUESTING ASSISTANCE” indicates that a request for assistance has been made on the assistance request screen 1200. The status “CHECKING RESPONSE” indicates that a response to the request for assistance has been received from the service provider and is ready to be checked.

The details display field 1002 is a field for displaying details of the assessment result of the device color adjustment on the target device corresponding to the pressed details button 1001a.

The OK button 1011 is a button for closing the device color adjustment result screen 1000. The request assistance button 1012 is a button for displaying the assistance request screen 1200 illustrated in FIG. 10 to make a request for assistance with the target device corresponding to the assessment result “NOT OK” among the assessment results of the target devices displayed in the color adjustment result display field 1001.

The read button 1021 is a button for causing the image reading apparatus 30 to reread the color chart CC for the target device selected in the color adjustment result display field 1001, for example.

The printing company as the user performs an operation of displaying a job color adjustment result screen 1100 as illustrated in FIG. 9 via the input unit 208 of the color adjustment system 20. Then, the display control unit 209 transmits a request to display the job color adjustment result screen 1100 to the color adjustment assistance system 40 via the communication unit 201. In response to the display request, the UI unit 402 of the color adjustment assistance system 40 transmits screen information of the job color adjustment result screen 1100 to the color adjustment system 20 via the communication unit 401. Along with the transmission of the screen information by the UI unit 402, the information transmission unit 404 transmits to the color adjustment system 20 the adjustment-related information and the device-related information to be used to display the job color adjustment result screen 1100. Then, the display control unit 209 causes the display 808 to display the job color adjustment result screen 1100.

The job color adjustment result screen 1100 is a screen for displaying a history of assessment results of the job color adjustment performed by the color adjustment system 20. As illustrated in FIG. 9, the job color adjustment result screen 1100 includes a color adjustment result display field 1101, a details display filed 1102, an OK button 1111, a request assistance button 1112, and a read button 1121.

The color adjustment result display field 1101 is a field for displaying the assessment result of the job color adjustment for each target job (i.e., job of the document data). In the example illustrated in FIG. 9, the target job (i.e., job of the document data), the sheet name, the assessment result, the pre-adjustment ΔE, the post-adjustment ΔE, and the status are displayed in association with each other in the color adjustment result display field 1101. In the color adjustment result display field 1101, a details column includes a details button 1101a for each target job. If the details button 1101a is pressed, the display control unit 209 brings the row of the corresponding target job into the selected state, and displays details of the assessment result in the details display field 1102. The status includes “CREATING COMMENT,” “REQUESTING ASSISTANCE,” and “CHECKING RESPONSE,” for example. The status “CREATING COMMENT” indicates that a comment such as a question to the service provider about the assessment result “NOT OK” of the job color adjustment is being created. The status “REQUESTING ASSISTANCE” indicates that a request for assistance has been made on the assistance request screen 1200. The status “CHECKING RESPONSE” indicates that a response to the request for assistance has been received from the service provider and is ready to be checked.

The details display field 1102 is a field for displaying details of the assessment result of the job color adjustment on the target job corresponding to the pressed details button 1101a.

The OK button 1111 is a button for closing the job color adjustment result screen 1100. The request assistance button 1112 is a button for displaying the assistance request screen 1200 illustrated in FIG. 10 to make a request for assistance with the target job corresponding to the assessment result “NOT OK” among the assessment results of the target jobs displayed in the color adjustment result display field 1101.

The read button 1121 is a button for causing the image reading apparatus 30 to reread the print sample PS or the reproduced image print RIP for the target job selected in the color adjustment result display field 1101, for example.

The printing company as the user presses the request assistance button 1012 in the device color adjustment result screen 1000 or the request assistance button 1112 in the job color adjustment result screen 1100 via the input unit 208 of the color adjustment system 20. Then, the display control unit 209 transmits a request to display the assistance request screen 1200 to the color adjustment assistance system 40 via the communication unit 201. In response to the display request, the UI unit 402 of the color adjustment assistance system 40 transmits screen information of the assistance request screen 1200 to the color adjustment system 20 via the communication unit 401. Along with the transmission of the screen information by the UI unit 402, the information transmission unit 404 transmits to the color adjustment system 20 the adjustment-related information and the device-related information to be used to display the assistance request screen 1200. Then, the display control unit 209 causes the display 808 to display the assistance request screen 1200.

The assistance request screen 1200 is a screen for requesting the color adjustment assistance system 40 to provide assistance with the target device or the target job corresponding to the assessment “NOT OK” of the device color adjustment or the job color adjustment. As illustrated in FIG. 10, the assistance request screen 1200 includes a job color adjustment result display field 1201, a device color adjustment result display field 1202, a comment input field 1211, an attach file button 1212, a file attachment display field 1213, a history display field 1221, and a send button 1231.

The job color adjustment result display field 1201 is a field for displaying the assessment result “NOT OK” of the job color adjustment for each target job (i.e., job of the document data). In the example illustrated in FIG. 10, the target job (i.e., job of the document data), the sheet name, the assessment result, the pre-adjustment ΔE, the post-adjustment ΔE, and the status are displayed in association with each other in the job color adjustment result display field 1201. In the job color adjustment result display field 1201, a desired target job is selectable.

The device color adjustment result display field 1202 is a field for displaying the assessment result “NOT OK” of the device color adjustment for each target device (i.e., the image forming apparatus 10). In the example illustrated in FIG. 10, the target device (i.e., the image forming apparatus 10), the sheet name, the assessment result, the mean ΔE, the maximum ΔE, and the status are displayed in association with each other in the device color adjustment result display field 1202. In the device color adjustment result display field 1202, a desired target device is selectable.

By checking the information displayed in the job color adjustment result display field 1201 and the device color adjustment result display field 1202, the user is able to grasp a list of target jobs and a list of target devices corresponding to the assessment “NOT OK” of the color adjustment. Further, for each of the target jobs and the target devices with the assessment “NOT OK,” the user is able to check the progress of interactive communication with the service provider as the status.

The comment input field 1211 is a field for the user to input a comment such as a question to the service provider when sending the color adjustment assistance system 40 a request for assistance with the target job selected in the job color adjustment result display field 1201 or the target device selected in the device color adjustment result display field 1202. When the comment is input in the comment input field 1211, the status of the selected target job or device may change to “CREATING COMMENT,” for example.

The attach file button 1212 is a button for selecting a file attachment to transmit when sending the color adjustment assistance system 40 the request for assistance with the target job selected in the job color adjustment result display field 1201 or the target device selected in the device color adjustment result display field 1202. The file attachment may be the data of a profile generated by the color adjustment system 20, the document data on which the job color adjustment is performed, the data of the color chart CC used in the device color adjustment, or the read data of the color chart CC, for example.

The file attachment display field 1213 is a field for displaying the file name of the file attachment selected through the operation of the attach file button 1212.

The history display field 1221 is a field for displaying a history of the comment of the user input in the comment input field 1211 and transmitted to the color adjustment assistance system 40 as the request for assistance and the response to the request for assistance (e.g., guidance or comment) received from the service provider via the color adjustment assistance system 40. By checking the history displayed in the history display field 1221, the user is able to grasp the history of past interactive communication with the service provider, which facilitates the resolution of the issue in the color adjustment.

The send button 1231 is a button for transmitting the comment input in the comment input field 1211 and the file attachment attached through the operation of the attach file button 1212 to the color adjustment assistance system 40 together with a message of request for assistance. When the send button 1231 is pressed, the color adjustment information transmission unit 207 transmits the comment input in the comment input field 1211 and the file attachment attached through the operation of the attach file button 1212 to the color adjustment assistance system 40 via the communication unit 201 as the adjustment-related information together with the message of request for assistance. That is, the above-described interactive communication enables the transmission of not only the comment but also the file attachment (e.g., the profile, the document data, or the read data of the color chart CC) prepared by the user, facilitating the resolution of the issue in the color adjustment. As well as the above-described information, the color adjustment information transmission unit 207 may also transmit to the color adjustment assistance system 40 the information of the image forming apparatus 10 subjected to the color adjustment (i.e., the target device information) and the history of color adjustments on the image forming apparatus 10 by the color adjustment system 20 as the adjustment-related information.

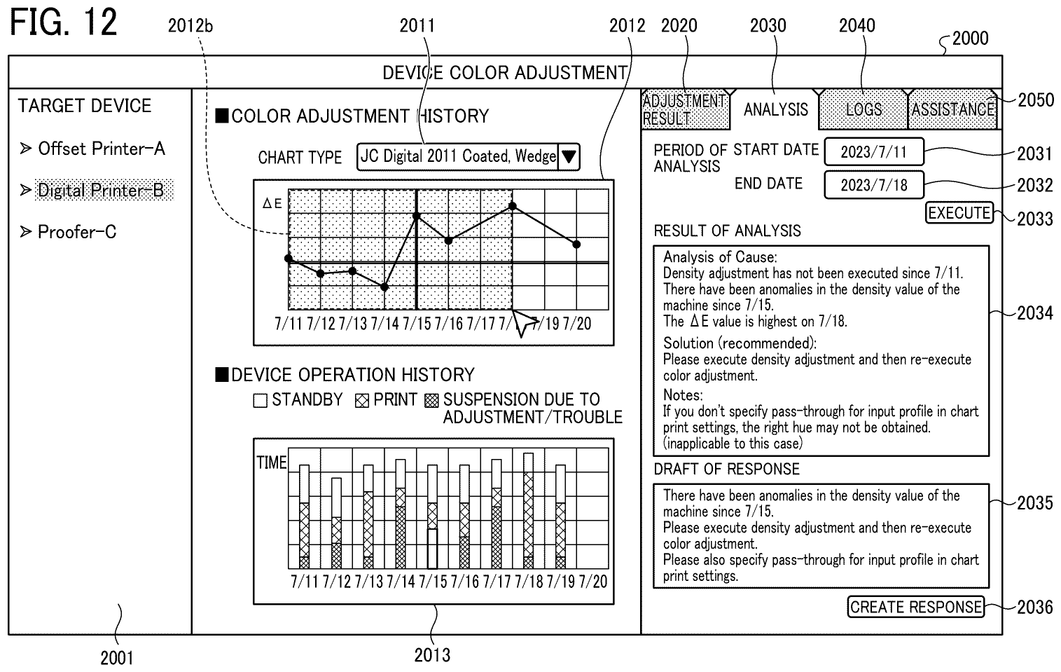

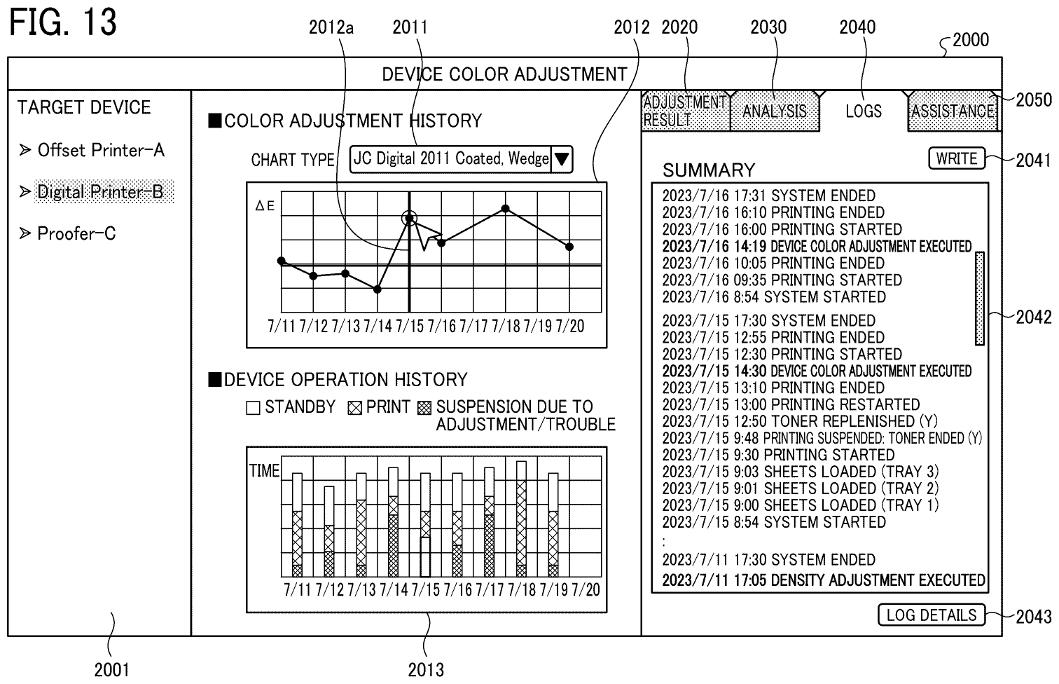

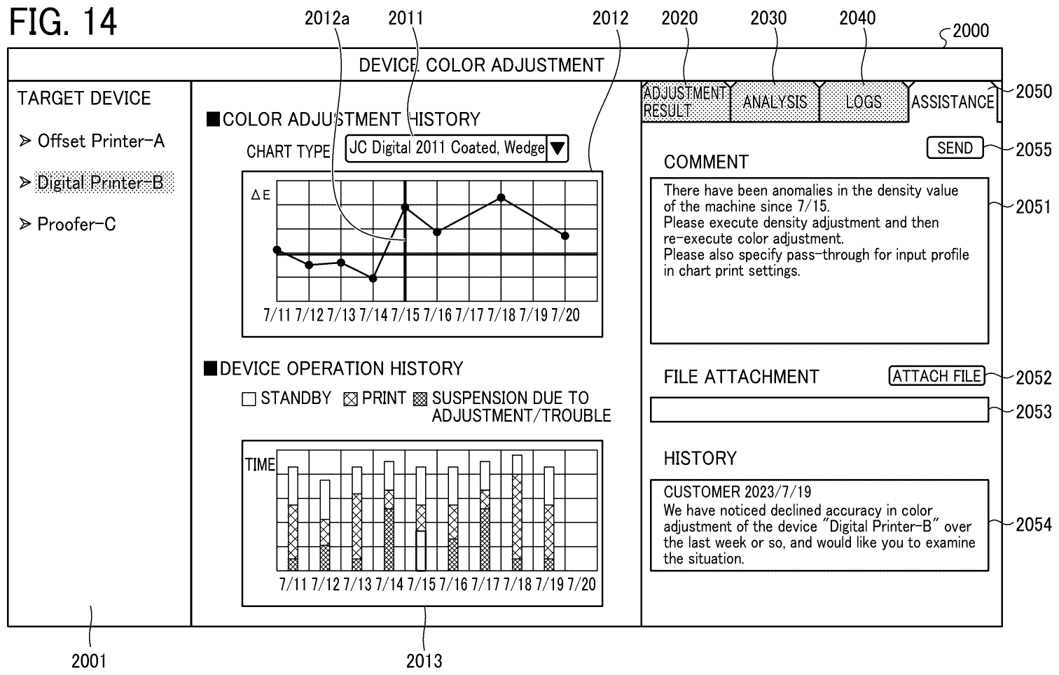

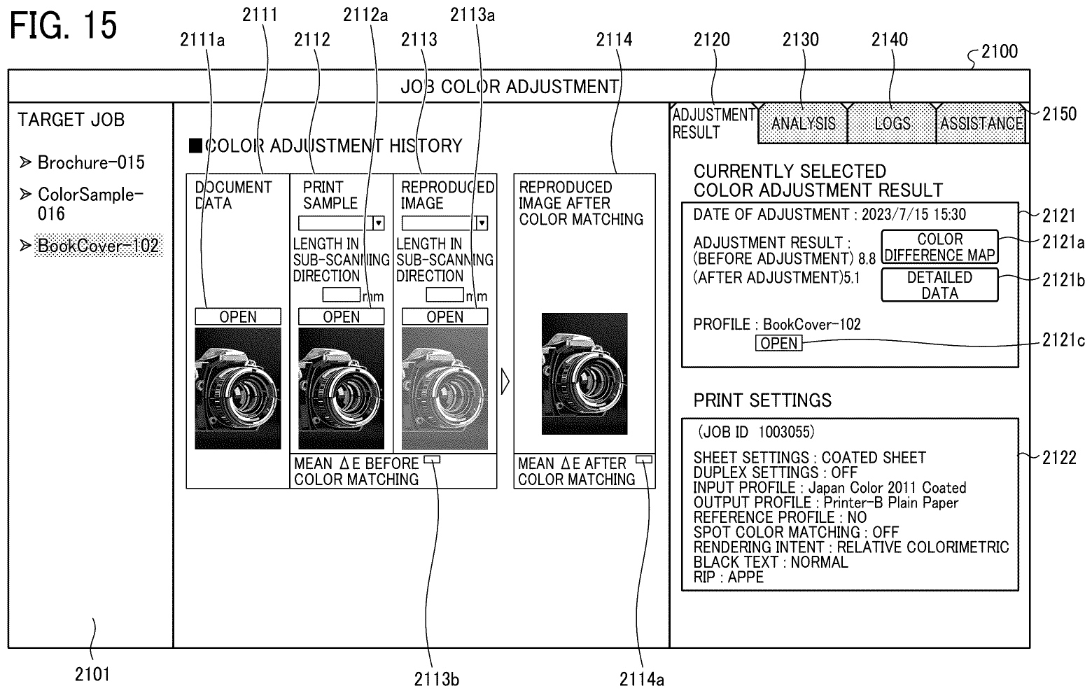

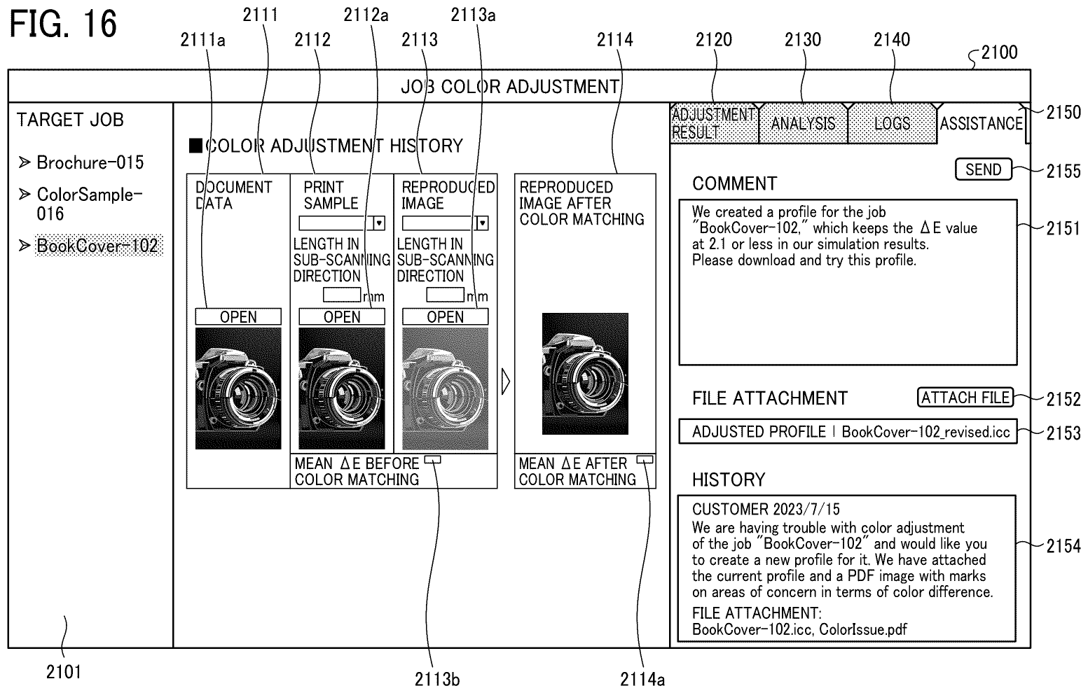

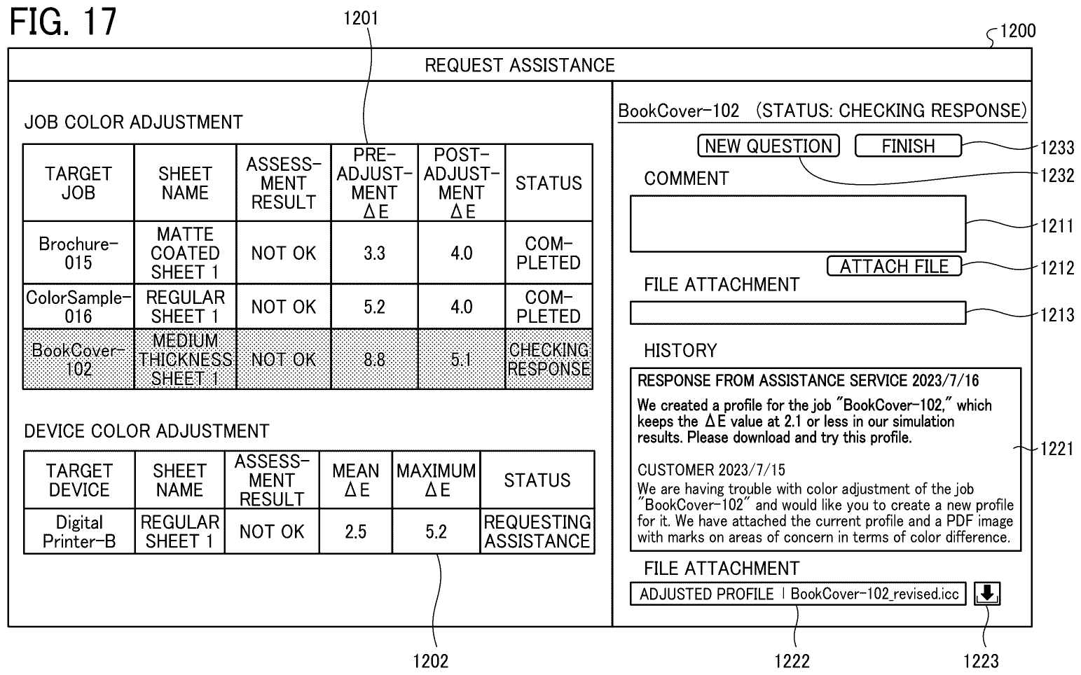

FIG. 11 is a diagram illustrating an example of a device color adjustment assistance screen displayed on a terminal of the service provider (i.e., the service provider terminal 60) when an adjustment result tab is selected. FIG. 12 is a diagram illustrating an example of the device color adjustment assistance screen displayed on the terminal of the service provider when an analysis tab is selected. FIG. 13 is a diagram illustrating an example of the device color adjustment assistance screen displayed on the terminal of the service provider when a logs tab is selected. FIG. 14 is a diagram illustrating an example of the device color adjustment assistance screen displayed on the terminal of the service provider when an assistance tab is selected. FIG. 15 is a diagram illustrating an example of a job color adjustment assistance screen displayed on the terminal of the service provider when an adjustment result tab is selected. FIG. 16 is a diagram illustrating an example of the job color adjustment assistance screen displayed on the terminal of the service provider when an assistance tab is selected. FIG. 17 is a diagram illustrating an example of an assistance request screen displayed in response to receipt of a response from the service provider. Screens displayed on the terminal of the service provider in the information processing system 1 of the embodiment will be described with reference to FIGS. 11 to 16. Further, with reference to FIG. 17, a description will be given of an operation in which the content of the response input on the service provider terminal 60 is displayed on a screen of the terminal of the printing company.

The service provider performs an operation of displaying the device color adjustment assistance screen 2000 (an example of an assistance screen) as illustrated in FIG. 11 via the input unit 602 of the service provider terminal 60. Then, the display control unit 603 transmits a request to display the device color adjustment assistance screen 2000 to the color adjustment assistance system 40 via the communication unit 601. In response to the display request, the UI unit 402 of the color adjustment assistance system 40 transmits screen information of the device color adjustment assistance screen 2000 to the service provider terminal 60 via the communication unit 401. Along with the transmission of the screen information by the UI unit 402, the information transmission unit 404 transmits to the service provider terminal 60 the adjustment-related information and the device-related information to be used to display the device color adjustment assistance screen 2000. Then, the display control unit 603 causes the display 808 to display the device color adjustment assistance screen 2000 reflecting the adjustment-related information and the device-related information. The service provider is thereby able to immediately use the above-described information as reference information to solve the issue in the color adjustment in response to receipt of the request for assistance.

The device color adjustment assistance screen 2000 is a screen for displaying the history of assessment results of the device color adjustment performed by the color adjustment system 20, the operating status of the target device, and the comment related to the request for assistance from the color adjustment system 20, for example. The device color adjustment assistance screen 2000 is also a screen for the service provider to input a response that is considered to be appropriate in response to the request for assistance. That is, the device color adjustment assistance screen 2000 is a screen for displaying information for supporting the resolution of the issue related to the device color adjustment. As illustrated in FIG. 11, the device color adjustment assistance screen 2000 includes a device selection field 2001, a color chart selection field 2011, a color adjustment history display field 2012, an operation history display field 2013, an adjustment result tab 2020, an analysis tab 2030, a logs tab 2040, and an assistance tab 2050. In the device color adjustment assistance screen 2000 illustrated in FIG. 11, the adjustment result tab 2020 is selected.

The device selection field 2001 is a field for displaying a list of target devices for the service provider to select a target device to display information of the target device in the color adjustment history display field 2012, the operation history display field 2013, the adjustment result tab 2020, the analysis tab 2030, the logs tab 2040, and the assistance tab 2050 based on the adjustment-related information and the device-related information.

The color chart selection field 2011 is a field for selecting the color chart CC corresponding to a history of device color adjustments to be displayed in the color adjustment history display field 2012. The color adjustment history display field 2012 is a field for displaying the history of device color adjustments included in the adjustment-related information transmitted by the information transmission unit 404, i.e., the history corresponding to the color chart CC selected in the color chart selection field 2011. In the color adjustment history display field 2012 illustrated in FIG. 11, a time-series graph of the color difference ΔE (the mean ΔE or the maximum ΔE) is displayed as the history of device color adjustments. A desired color difference ΔE is selectable from the graph displayed in the color adjustment history display field 2012, and the selected color difference ΔE is represented by a currently selected object 2012a.

The operation history display field 2013 is a field for displaying a device operation history, which is included in the device-related information transmitted from the information transmission unit 404 and represents the operating status of the target device selected in the device selection field 2001.

The adjustment result tab 2020 is a tab for displaying details of the result of device color adjustment corresponding to the color difference ΔE selected with the currently selected object 2012a. A screen field displayed with the selection of the adjustment result tab 2020 includes a color adjustment result display field 2021 and a print settings display field 2022. The color adjustment result display field 2021 includes a color chart display field 2021a, a file button 2021b, and a detailed data button 2021c.

The color chart display field 2021a is a field for displaying the image of the read data of the color chart CC used in the device color adjustment. The file button 2021b is a button for opening the output profile generated in the device color adjustment. The detailed data button 2021c is a button for displaying detailed data of the device color adjustment.

The print settings display field 2022 is a field for displaying print settings information in printing the color chart CC used in the device color adjustment corresponding to the color difference ΔE selected with the currently selected object 2012a.

The analysis tab 2030 is a tab for displaying, for example, the analysis result of the device color adjustment on the target device selected in the device selection field 2001. The logs tab 2040 is a tab for displaying various logs of the target device selected in the device selection field 2001. The assistance tab 2050 is a tab for displaying a field for the service provider to input the response to the request for assistance with the target device selected in the device selection field 2001.

When the service provider performs an operation of selecting the analysis tab 2030 via the input unit 602 of the service provider terminal 60, the display control unit 603 causes the display 808 to display the device color adjustment assistance screen 2000 illustrated in FIG. 12. That is, the analysis tab 2030 is selected in the device color adjustment assistance screen 2000 illustrated in FIG. 12.

A screen field displayed with the selection of the analysis tab 2030 includes a start date input field 2031, an end date input field 2032, an execute button 2033, an analysis result display field 2034, a response draft display filed 2035, and a create response button 2036.

The start date input field 2031 is a field for inputting the start date of the period of analysis by the analysis unit 405 on the graph of device color adjustment displayed in the color adjustment history display field 2012. The end date input field 2032 is a field for inputting the end date of the period of analysis by the analysis unit 405 on the graph of device color adjustment displayed in the color adjustment history display field 2012. With the dates input in the start date input field 2031 and the end date input field 2032, the period of analysis by the analysis unit 405 is specified. Alternatively, on the graph displayed in the color adjustment history display field 2012, the period of analysis may be specified with a selected area 2012b selected through a drag operation with the input unit 602, for example, as illustrated in FIG. 12. Further, the display control unit 603 may generate a bit-mapped image file of a part of the graph in the color adjustment history display field 2012 specified with the selected area 2012b, and may store the generated file in the service provider terminal 60 or the color adjustment assistance system 40 (i.e., the storage unit 408).

The execute button 2033 is a button for sending the color adjustment assistance system 40 a request for analysis with device color adjustment history information corresponding to the period specified with the dates in the start date input field 2031 and the end date input field 2032 or specified with the selected area 2012b. When the execute button 2033 is pressed and the history information of the period is transmitted to the color adjustment assistance system 40 together with the request for analysis, the analysis unit 405 of the color adjustment assistance system 40 analyzes the issue in the device color adjustment with the history information. The analysis unit 405 then automatically generates a comment describing the result of analysis, and displays the generated comment in the analysis result display field 2034. Further, the analysis unit 405 automatically generates a comment describing a draft of the response to the user (i.e., the printing company), and displays the generated comment in the response draft display filed 2035.

The create response button 2036 is a button for copying the comment of the response draft displayed in the response draft display field 2035 to a later-described comment input field 2051 in the screen field of the assistance tab 2050 illustrated in FIG. 14. In the comment input field 2051 displayed with the selection of the assistance tab 2050, therefore, the service provider is able to readily create a comment by editing the copied comment with no need to create a response comment from nothing.

When the service provider performs an operation of selecting the logs tab 2040 via the input unit 602 of the service provider terminal 60, the display control unit 603 causes the display 808 to display the device color adjustment assistance screen 2000 illustrated in FIG. 13. That is, the logs tab 2040 is selected in the device color adjustment assistance screen 2000 illustrated in FIG. 13.

A screen field displayed with the selection of the logs tab 2040 includes a write button 2041, a logs display field 2042, and a log details button 2043.

The write button 2041 is a button for writing in a file the logs of the target device displayed in the logs display field 2042. The logs display field 2042 is a field for displaying logs based on the device-related information (e.g., the operating status and the error history) and the adjustment-related information (e.g., the device color adjustment history and the operation history) transmitted by the information transmission unit 404. The log details button 2043 is a button for displaying details of the logs.

When the service provider performs an operation of selecting the assistance tab 2050 via the input unit 602 of the service provider terminal 60, the display control unit 603 causes the display 808 to display the device color adjustment assistance screen 2000 illustrated in FIG. 14. That is, the assistance tab 2050 is selected in the device color adjustment assistance screen 2000 illustrated in FIG. 14.

A screen field displayed with the selection of the assistance tab 2050 includes a comment input field 2051, an attach file button 2052, a file attachment display field 2053, a history display field 2054, and a send button 2055.

The comment input field 2051 is a field for inputting a comment as the response to the request for assistance from the color adjustment system 20 in accordance with an operation input by the service provider with the input unit 602. The comment describes, for example, a method and guidance to address the assessment “NOT OK” of the device color adjustment on the target device selected in the device selection field 2001. For example, if there is an issue in the maintenance of the image forming apparatus 10, the comment may recommend the device color adjustment. If there is an issue in the profile, the comment may describe a method of creating an appropriate profile, for example. As described above, if the create response button 2036 is pressed, the comment of the response draft displayed in the response draft display field 2035 is copied to the comment input field 2051. In this case, the service provider may input an operation with the input unit 602 to make a correction or addition to the comment in the comment input field 2051.

The attach file button 2052 is a button for selecting a file attachment, such as a profile created by the service provider, as the response to the request for assistance from the color adjustment system 20. That is, if there is an issue in the profile, the service provider may create an appropriate profile, for example, and respond with the created profile as the file attachment. Further, the above-generated bitmap file of the graph selected with the selected area 2012b may be selected as the file attachment with the operation of the attach file button 2052. With the bitmap file, therefore, the service provider is able to present the user with specific information of the cause of the issue in the color adjustment, consequently facilitating the resolution of the issue in the color adjustment.

The file attachment display field 2053 is a field for displaying the file name of the file attachment selected through the operation of the attach file button 2052.

The history display field 2054 is a field for displaying a history of the comment of the service provider input in the comment input field 2051 and transmitted to the color adjustment system 20 as the response to the request for assistance and the comment (e.g., question) received from the printing company via the color adjustment system 20 as the request for assistance. By checking the history displayed in the history display field 2054, the service provider is able to grasp the history of past interactive communication with the printing company, which helps the service provider to create an appropriate response for solving the issue in the color adjustment.

The send button 2055 is a button for transmitting the comment of the service provider displayed in the comment input field 2051 and the file attachment attached through the operation of the attach file button 2052 to the color adjustment system 20 via the color adjustment assistance system 40 as the response to the request for assistance. When the send button 2055 is pressed, the communication unit 601 transmits the comment of the service provider displayed in the comment input field 2051 and the file attachment attached through the operation of the attach file button 2052 to the color adjustment assistance system 40 as the response to the request for assistance. Then, the response acquisition unit 406 of the color adjustment assistance system 40 acquires the comment and the file attachment. That is, the above-described interactive communication enables the transmission of not only the comment but also the file attachment (e.g., the profile or the document data) prepared and adjusted by the service provider, facilitating the resolution of the issue in the color adjustment. Then, via the communication unit 401, the information notification unit 407 of the color adjustment assistance system 40 notifies the color adjustment system 20 of the response acquired by the response acquisition unit 406.

The service provider performs an operation of displaying a job color adjustment assistance screen 2100 (an example of the assistance screen) as illustrated in FIG. 15 via the input unit 602 of the service provider terminal 60. Then, the display control unit 603 transmits a request to display the job color adjustment assistance screen 2100 to the color adjustment assistance system 40 via the communication unit 601. In response to the display request, the UI unit 402 of the color adjustment assistance system 40 transmits screen information of the job color adjustment assistance screen 2100 to the service provider terminal 60 via the communication unit 401. Along with the transmission of the screen information by the UI unit 402, the information transmission unit 404 transmits to the service provider terminal 60 the adjustment-related information and the device-related information to be used to display the job color adjustment assistance screen 2100. Then, the display control unit 603 causes the display 808 to display the job color adjustment assistance screen 2100 reflecting the adjustment-related information and the device-related information. The service provider is thereby able to immediately use the above-described information as reference information to solve the issue in the color adjustment in response to receipt of the request for assistance.

The job color adjustment assistance screen 2100 is a screen for displaying a history of assessment results of the job color adjustment performed by the color adjustment system 20 and the comment related to the request for assistance from the color adjustment system 20, for example. The job color adjustment assistance screen 2100 is also a screen for the service provider to input a response that is considered to be appropriate in response to the request for assistance. That is, the job color adjustment assistance screen 2100 is a screen for displaying information for supporting the resolution of the issue related to the job color adjustment. As illustrated in FIG. 15, the job color adjustment assistance screen 2100 includes a job selection field 2101, a document data display field 2111, a print sample display field 2112, a reproduced image display field 2113, a pre-color matching mean color difference display field 2113b, a post-color matching reproduced image display field 2114, an adjustment result tab 2120, an analysis tab 2130, a logs tab 2140, and an assistance tab 2150. In the job color adjustment assistance screen 2100 illustrated in FIG. 15, the adjustment result tab 2120 is selected.

The job selection field 2101 is a field for displaying a list of target jobs for the service provider to select a target job to display information of the target job in the document data display field 2111, the print sample display field 2112, the reproduced image display field 2113, the pre-color matching mean color difference display field 2113b, the post-color matching reproduced image display field 2114, the adjustment result tab 2120, the analysis tab 2130, the logs tab 2140, and the assistance tab 2150 based on the adjustment-related information and the device-related information.

The document data display field 2111 is a field for displaying the image of the document data of the target job selected in the job selection field 2101. The document data display field 2111 includes an open button 2111a for opening the document data.

The print sample display field 2112 is a field for displaying the image of the print sample PS based on the read data of the print sample PS corresponding to the target job selected in the job selection field 2101. The print sample display field 2112 includes an open button 2112a for opening the read data of the print sample PS.

The reproduced image display field 2113 is a field for displaying the reproduced image based on the read data of the reproduced image print RIP corresponding to the target job selected in the job selection field 2101. The reproduced image display field 2113 includes an open button 2113a for opening the read data of the reproduced image print RIP.

The pre-color matching mean color difference display field 2113b is a field for displaying the pre-adjustment ΔE of the target job selected in the job selection field 2101.

The post-color matching reproduced image display field 2114 is a field for displaying a post-color matching reproduced image of the target job selected in the job selection field 2101, i.e., the image obtained after color matching on the reproduced image displayed in the reproduced image display field 2113. The post-color matching reproduced image display field 2114 includes a post-color matching mean color difference display field 2114a for displaying the post-adjustment ΔE of the target job selected in the job selection field 2101.

The adjustment result tab 2120 is a tab for displaying details of the result of job color adjustment corresponding to the target job selected in the job selection field 2101. A screen field displayed with the selection of the adjustment result tab 2120 includes a color adjustment result display field 2121 and a print settings display field 2122. The color adjustment result display field 2121 includes a color difference map button 2121a, a detailed data button 2121b, and a file button 2121c.

The color difference map button 2121a is a button for displaying a color difference map generated in the job color adjustment corresponding to the target job selected in the job selection field 2101. The detailed data button 2121b is a button for displaying detailed data of the job color adjustment. The file button 2121c is a button for opening the input profile generated in the job color adjustment.

The print settings display field 2122 is a field for displaying print settings information in printing the document data of the target job selected in the job selection field 2101.

The analysis tab 2130 is a tab for displaying, for example, the analysis result of the job color adjustment on the target job selected in the job selection field 2101. The logs tab 2140 is a tab for displaying various logs related to the target job selected in the job selection field 2101. The assistance tab 2150 is a tab for displaying a field for the service provider to input the response to the request for assistance with the target job selected in the job selection field 2101.

When the service provider performs an operation of selecting the assistance tab 2150 via the input unit 602 of the service provider terminal 60, the display control unit 603 causes the display 808 to display the job color adjustment assistance screen 2100 illustrated in FIG. 16. That is, the assistance tab 2150 is selected in the job color adjustment assistance screen 2100 illustrated in FIG. 16.

A screen field displayed with the selection of the assistance tab 2150 includes a comment input field 2151, an attach file button 2152, a file attachment display field 2153, a history display field 2154, and a send button 2155.

The comment input field 2151 is a field for inputting a comment as the response to the request for assistance from the color adjustment system 20 in accordance with an operation input by the service provider with the input unit 602. The comment describes, for example, a method and guidance to address the assessment “NOT OK” of the job color adjustment on the target job selected in the job selection field 2101. For example, if there is an issue in the profile, the comment may describe a method of creating an appropriate profile. If there is an issue in the document data, the comment may describe a method of adjusting the document data or may provide guidance on the print settings, for example. Similarly as in the above-described comment input field 2051, a comment of a response draft automatically generated by the analysis unit 405 may be copied to the comment input field 2151. In this case, the service provider may input an operation with the input unit 602 to make a correction or addition to the comment in the comment input field 2151.

The attach file button 2152 is a button for selecting a file attachment, such as a profile created by the service provider or document data adjusted by the service provider, as the response to the request for assistance from the color adjustment system 20. That is, if there is an issue in the profile or the document data, the service provider may create an appropriate profile or adjust the document data and respond with the created profile or the adjusted document data as the file attachment.

The file attachment display field 2153 is a field for displaying the file name of the file attachment selected through the operation of the attach file button 2152.

The history display field 2154 is a field for displaying a history of the comment of the service provider input in the comment input field 2151 and transmitted to the color adjustment system 20 as the response to the request for assistance and the comment (e.g., question) received from the printing company via the color adjustment system 20 as the request for assistance. By checking the history displayed in the history display field 2154, the service provider is able to grasp the history of past interactive communication with the printing company, which helps the service provider to create an appropriate response for solving the issue in the color adjustment.

The send button 2155 is a button for transmitting the comment of the service provider displayed in the comment input field 2151 and the file attachment attached through the operation of the attach file button 2152 to the color adjustment system 20 via the color adjustment assistance system 40 as the response to the request for assistance. When the send button 2155 is pressed, the communication unit 601 transmits the comment of the service provider displayed in the comment input field 2151 and the file attachment attached through the operation of the attach file button 2152 to the color adjustment assistance system 40 as the response to the request for assistance. The response acquisition unit 406 of the color adjustment assistance system 40 then acquires the comment and the file attachment. Then, via the communication unit 401, the information notification unit 407 of the color adjustment assistance system 40 notifies the color adjustment system 20 of the response acquired by the response acquisition unit 406. Thereby, as illustrated in FIG. 17, the content of the response notified by the information notification unit 407 is displayed as a history on the assistance request screen 1200 displayed on the color adjustment system 20.

In the example of the assistance request screen 1200 illustrated in FIG. 17, a response to a request for assistance with a target job “BookCover-102” is notified by the color adjustment assistance system 40. Consequently, the status of the target job “BookCover-102” in the job color adjustment result display field 1201 is updated to “CHECKING RESPONSE,” and the assistance request screen 1200 displays a file attachment display field 1222, a download button 1223, a new question button 1232, and a finish button 1233.

Specifically, the display control unit 209 adds the comment of the service provider, which is included in the response notified by the information notification unit 407, to the history in the history display field 1221. The display control unit 209 further displays, in the file attachment display field 1222, the file name of the file attachment from the service provider included in the response notified by the information notification unit 407. By pressing the download button 1223, the user (i.e., the printing company) is able to download the file attachment corresponding to the file name displayed in the file attachment display field 1222.

The new question button 1232 is a button for transmitting a comment input in the comment input field 1211 by the user and a file attachment attached through the operation of the attach file button 1212 to the color adjustment assistance system 40 together with a message of additional question in response to the response notified by the information notification unit 407. Thereby, the user is able to send a response to the response from the service provider. The interactive communication between the user and the service provider is thus repeated, facilitating the resolution of issue related to the color adjustment.

The finish button 1233 is a button to be pressed when the user (i.e., the printing company) decides that the issue related to the color adjustment has been solved with the response of the service provider notified by the information notification unit 407. When the finish button 1233 is pressed, the display control unit 209 updates the status of the corresponding target job or device to “COMPLETED.”

If the analysis tab 2130 or the logs tab 2140 is selected in the job color adjustment assistance screen 2100, information is displayed which is similar to that displayed when the analysis tab 2030 or the logs tab 2040 is selected in the above-described device color adjustment assistance screen 2000.

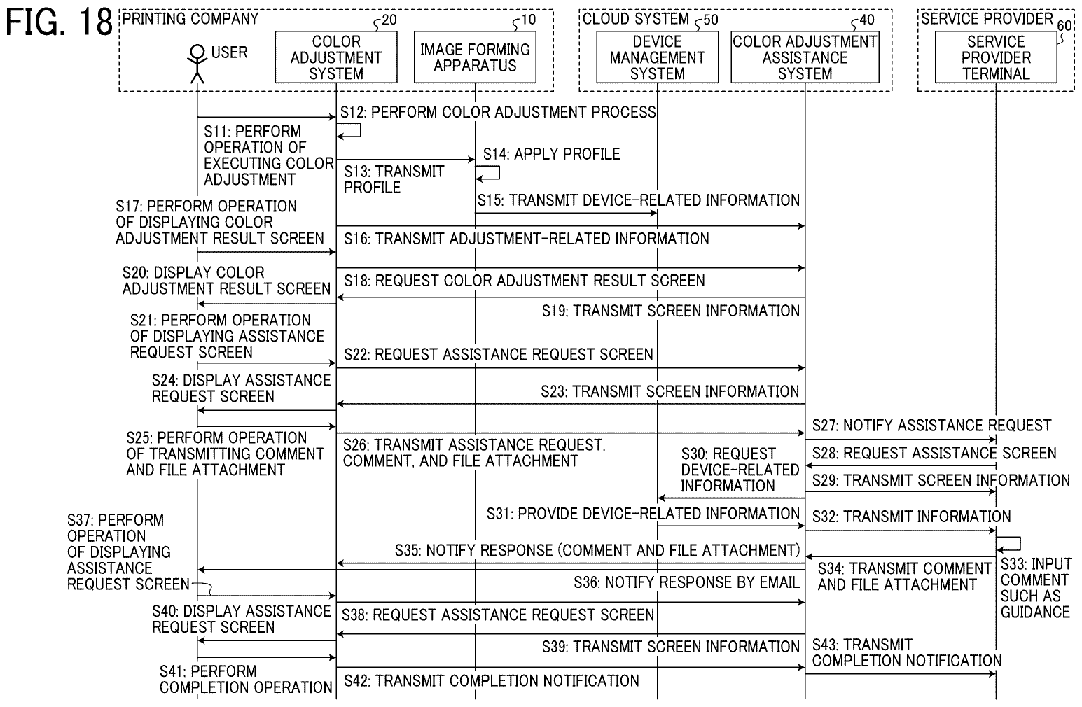

FIG. 18 is a sequence diagram illustrating an exemplary procedure of overall operation of the information processing system 1 of the embodiment. A procedure of overall operation of the information processing system 1 of the embodiment will be described with reference to FIG. 18.

At step S11, the user (i.e., the printing company) performs an operation of executing the device color adjustment or the job color adjustment via the input unit 208 of the color adjustment system 20.

At step S12, the color information acquisition unit 203 of the color adjustment system 20 acquires the read data represented by the colorimetric values (e.g., the Lab values) from the image reading apparatus 30 via the communication unit 201. In the device color adjustment, the read data is obtained through the reading process by the image reading apparatus 30 to read the color chart CC and the reproduced image print RIP printed by the image forming apparatus 10. In the job color adjustment, the read data is obtained through the reading process by the image reading apparatus 30 to read the print sample PS. In the job color adjustment, the calculation unit 204 of the color adjustment system 20 calculates the color difference ΔE between the image of the print sample PS and the pre-color matching reproduced image and the color difference ΔE between the image of the print sample PS and the post-color matching reproduced image. For example, for each of the pixel values of the pixels in the image of the print sample PS, the calculation unit 204 calculates the color difference ΔE from the pixel value of the corresponding pixel in the pre-color matching reproduced image and the color difference ΔE from the pixel value of the corresponding pixel in the post-color matching reproduced image. The calculation unit 204 further calculates the mean value of the thus-calculated color differences ΔE, i.e., the mean color difference ΔE. The mean color difference ΔE before the color matching and the mean color difference ΔE after the color matching may be referred to as the pre-adjustment ΔE and the post-adjustment ΔE, respectively. In the device color adjustment, the calculation unit 204 calculates the mean value of the color differences ΔE (i.e., the mean ΔE) and the maximum color difference ΔE (i.e., the maximum ΔE) for each color adjustment patch based on the read data of the color chart CC. The assessment results corresponding to the color differences ΔE are stored in the storage unit 210 as the color adjustment history. The color adjustment unit 205 of the color adjustment system 20 generates the input profile in the job color adjustment by performing an adjustment to make the color of the reproduced image match the color of the image of the print sample PS. The color adjustment unit 205 further generates the output profile in the device color adjustment by performing a commonly used color adjustment process to make the colorimetric values of the printed color adjustment patches reproduce the already known color values of the color adjustment patches on the color chart CC.

At step S13, the profile transmission unit 206 of the color adjustment system 20 transmits the profile generated by the color adjustment unit 205 to the image forming apparatus 10 via the communication unit 201.

At step S14, the print control unit 103 of the image forming apparatus 10 applies the profile transmitted by the profile transmission unit 206 to printing.

At step S15, the device information transmission unit 105 of the image forming apparatus 10 periodically collects the device-related information of the image forming apparatus 10, and transmits the collected device-related information to the device management system 50 via the communication unit 101. Then, the information collection unit 502 of the device management system 50 collects (i.e., acquires) the device-related information from the image forming apparatus 10 via the communication unit 501. The information collection unit 502 stores the collected device-related information in the storage unit 504.

At step S16, the color adjustment information transmission unit 207 of the color adjustment system 20 collects the adjustment-related information related to the job color adjustment and the device color adjustment on the image forming apparatus 10, and transmits the collected adjustment-related information to the color adjustment assistance system 40 via the communication unit 201. The information acquisition unit 403 of the color adjustment assistance system 40 acquires the adjustment-related information from the color adjustment system 20 via the communication unit 401, and stores the acquired adjustment-related information in the storage unit 408.

At step S17, the printing company as the user performs an operation of displaying the device color adjustment result screen 1000 or the job color adjustment result screen 1100 via the input unit 208 of the color adjustment system 20.

At step S18, the display control unit 209 of the color adjustment system 20 transmits a color adjustment result screen request, i.e., a request to display the device color adjustment result screen 1000 or the job color adjustment result screen 1100, to the color adjustment assistance system 40 via the communication unit 201.

At step S19, in response to the display request, the UI unit 402 of the color adjustment assistance system 40 transmits the screen information of the device color adjustment result screen 1000 or the job color adjustment result screen 1100 to the color adjustment system 20 via the communication unit 401. Along with the transmission of the screen information by the UI unit 402, the information transmission unit 404 transmits to the color adjustment system 20 the adjustment-related information and the device-related information to be used to display the device color adjustment result screen 1000 or the job color adjustment result screen 1100.

At step S20, the display control unit 209 causes the display 808 to display the device color adjustment result screen 1000 or the job color adjustment result screen 1100.

At step S21, the user presses the request assistance button 1012 or 1112 to request assistance with the color adjustment result corresponding to the assessment “NOT OK” displayed on the device color adjustment result screen 1000 or the job color adjustment result screen 1100.

At step S22, the display control unit 209 transmits an assistance request screen request, i.e., a request to display the assistance request screen 1200, to the color adjustment assistance system 40 via the communication unit 201.

At step S23, in response to the display request, the UI unit 402 of the color adjustment assistance system 40 transmits the screen information of the assistance request screen 1200 to the color adjustment system 20 via the communication unit 401. Along with the transmission of the screen information by the UI unit 402, the information transmission unit 404 transmits to the color adjustment system 20 the adjustment-related information and the device-related information to be used to display the assistance request screen 1200.

At step S24, the display control unit 209 causes the display 808 to display the assistance request screen 1200.

At step S25, in the job color adjustment result display field 1201 or the device color adjustment result display field 1202 of the assistance request screen 1200, the user selects the target job or device for which the request for assistance is to be made. The user then inputs a comment in the comment input field 1211. For example, the comment may be a question or request to solve the issue in the color adjustment on the selected target job or device assessed as “NOT OK.” The user selects a file attachment as necessary by operating the attach file button 1212 and presses the send button 1231.

At step S26, in response to the pressing of the send button 1231 by the user, the color adjustment information transmission unit 207 transmits the comment input in the comment input field 1211 and the file attachment attached through the operation of the attach file button 1212 to the color adjustment assistance system 40 via the communication unit 201 as the adjustment-related information together with a message of request for assistance. As well as the above-described information, the color adjustment information transmission unit 207 may transmit to the color adjustment assistance system 40 the information of the image forming apparatus 10 subjected to the color adjustment (i.e., the target device information) and the history of color adjustments on the image forming apparatus 10 by the color adjustment system 20 as the adjustment-related information.

At step S27, in response to receipt of the request for assistance from the color adjustment system 20, the communication unit 401 of the color adjustment assistance system notifies the service provider terminal 60 of the request. In this case, the communication unit 401 may notify the request by transmitting an electronic mail to the service provider terminal 60 or an information terminal used by the service provider, for example.

At step S28, the service provider performs an operation of displaying the device color adjustment assistance screen 2000 or the job color adjustment assistance screen 2100 depending on whether the request for assistance notified to the service provider terminal 60 is for the device color adjustment or the job color adjustment. The following description will be given on the assumption that the request for assistance is for the device color adjustment.

The service provider performs the operation of displaying the device color adjustment assistance screen 2000 as illustrated in FIG. 11 via the input unit 602 of the service provider terminal 60. Thereby, the display control unit 603 transmits a request to display the device color adjustment assistance screen 2000 to the color adjustment assistance system 40 via the communication unit 601.

At step S29, in response to the display request, the UI unit 402 of the color adjustment assistance system 40 transmits the screen information of the device color adjustment assistance screen 2000 to the service provider terminal 60 via the communication unit 401. Along with the transmission of the screen information by the UI unit 402, the information transmission unit 404 transmits to the service provider terminal 60 the adjustment-related information and the device-related information to be used to display the device color adjustment assistance screen 2000. The display control unit 603 then causes the display 808 to display the device color adjustment assistance screen 2000.

At step S30, via the communication unit 401, the information acquisition unit 403 of the color adjustment assistance system 40 requests the device management system 50 to provide the device-related information of the image forming apparatus 10, which is represented by the target device information included in the adjustment-related information related to the request for assistance.

At step S31, in response to the request, the information providing unit 503 of the device management system 50 provides the device-related information of the image forming apparatus 10 represented by the target device information to the color adjustment assistance system 40 via the communication unit 501. The information acquisition unit 403 of the color adjustment assistance system 40 acquires the device-related information from the device management system 50 via the communication unit 401.

At step S32, the information transmission unit 404 of the color adjustment assistance system 40 transmits the adjustment-related information and the device-related information acquired by the information acquisition unit 403 to the service provider terminal 60 via the communication unit 401. Then, the display control unit 603 of the service provider terminal 60 reflects the adjustment-related information and the device-related information in the device color adjustment assistance screen 2000.

At step S33, the service provider selects at least one of the adjustment result tab 2020, the analysis tab 2030, or the logs tab 2040 on the device color adjustment assistance screen 2000 to check information related to the adjustment-related information and the device-related information. For example, in the screen field displayed with the selection of the analysis tab 2030, the service provider inputs dates in the start date input field 2031 and the end date input field 2032 to specify the period, and presses the execute button 2033. Then, the history information of the period is transmitted to the color adjustment assistance system 40 together with a request for analysis. With the history information, the analysis unit 405 of the color adjustment assistance system 40 analyses the issue in the device color adjustment, automatically generates a comment describing the result of analysis, and displays the comment in the analysis result display field 2034. Further, the analysis unit 405 automatically generates a comment describing a draft of the response to the user (i.e., the printing company), and displays the comment in the response draft display field 2035. When the create response button 2036 is pressed, the comment of the response draft displayed in the response draft display field 2035 is copied to the comment input field 2051 of the assistance tab 2050. Then, in the screen field displayed with the selection of the assistance tab 2050, the service provider inputs a comment in the comment input field 2051 as the response to the request for assistance from the color adjustment system 20. For example, the comment describes a method and guidance to address the assessment “NOT OK” of the device color adjustment on the target device selected in the device selection field 2001. If the comment of the response draft displayed in the response draft display field 2035 is copied to the comment input field 2051, as described above, the service provider may make a correction or addition to the comment. The service provider further operates the attach file button 2052 as necessary to select a file attachment, such as a profile created by the service provider, as the response to the request for assistance.

At step S34, when the service provider presses the send button 2055, the communication unit 601 transmits the comment of the service provider displayed in the comment input field 2051 and the file attachment attached through the operation of the attach file button 2052 to the color adjustment assistance system 40 as the response to the request for assistance. Then, the response acquisition unit 406 of the color adjustment assistance system acquires the comment and the file attachment.

At step S35, via the communication unit 401, the information notification unit 407 of the color adjustment assistance system 40 notifies the color adjustment system 20 of the response (i.e., the comment and the file attachment) acquired by the response acquisition unit 406. Alternatively, at step S36, the information notification unit 407 may transmit an electronic mail to an information terminal used by the user, for example, to notify the response.

At step S37, the user checks that the status has been updated to “CHECKING RESPONSE” after the receipt of the notification about the color adjustment result with the assessment “NOT OK” displayed on the device color adjustment result screen 1000. The user then presses the request assistance button 1012.

At step S38, the display control unit 209 transmits the assistance request screen request, i.e., the request to display the assistance request screen 1200, to the color adjustment assistance system 40 via the communication unit 201.

At step S39, in response to the display request, the UI unit 402 transmits the screen information of the assistance request screen 1200 to the color adjustment system 20 via the communication unit 401. Along with the transmission of the screen information by the UI unit 402, the information transmission unit 404 transmits to the color adjustment system 20 the adjustment-related information and the device-related information to be used to display the assistance request screen 1200.

At step S40, the display control unit 209 causes the display 808 to display the assistance request screen 1200. In this case, the display control unit 209 reflects the comment of the response notified by the information notification unit 407 in the history display field 1221, and reflects the file attachment of the response in the file attachment display field 1222. By pressing the download button 1223, the user (i.e., the printing company) is able to download the file attachment corresponding to the file name displayed in the file attachment display field 1222. Further, the user may, as necessary, input a comment in the comment input field 1211 to ask an additional question, attach a new file attachment by operating the attach file button 1212, and press the new question button 1232 to transmit the comment and the file attachment to the color adjustment assistance system 40 together with a message of additional question.

At step S41, if the user (i.e., the printing company) decides that the issue related to the color adjustment has been solved with the response of the service provider notified by the information notification unit 407, the user presses the finish button 1233. When the finish button 1233 is pressed, the display control unit 209 updates the status of the corresponding target device to “COMPLETED.”

At step S42, the display control unit 209 transmits a completion notification to the color adjustment assistance system 40 via the communication unit 201. At step S43, the communication unit 401 of the color adjustment assistance system 40 transfers the completion notification to the service provider terminal 60.

The overall operation of the information processing system 1 is thus performed with the above-described exemplary procedure of steps S11 to S43.

As described above, in the information processing system 1 of the embodiment, the information acquisition unit 403 acquires the device-related information related to the operation of the image forming apparatus 10 and the adjustment-related information related to the color adjustment by the color adjustment system 20. The storage unit 408 stores the device-related information and the adjustment-related information acquired by the information acquisition unit 403. In accordance with the operation performed on the input unit 208 by the user of the image forming apparatus 10, the color adjustment information transmission unit 207 transmits the request for assistance with the issue related to the color adjustment to the color adjustment assistance system 40. When the color adjustment assistance system 40 receives the request for assistance, the display control unit 603 (and the UI unit 402) causes the display 808 of the service provider terminal 60 used by the service provider to display the assistance screen based on the information corresponding to the request and included in the device-related information and the adjustment-related information acquired by the information acquisition unit 403. The assistance screen (i.e., the device color adjustment assistance screen 2000 or the job color adjustment assistance screen 2100) displays the information for supporting the resolution of the issue related to the color adjustment. Further, when the color adjustment assistance system 40 receives the request for assistance, the information notification unit 407 notifies the color adjustment system 20 of the response input by the service provider as the response to the request, thereby helping the user to solve the issue related to the color adjustment, even if the user has no specialized knowledge or experiences.

In the information processing system 1 of the embodiment, the detection unit 211 detects the occurrence of the issue related to the color adjustment when a particular condition is met. When the detection unit 211 detects the occurrence of the issue related to the color adjustment, the color adjustment information transmission unit 207 transmits the request for assistance to the color adjustment assistance system 40. Thereby, the request for assistance is automatically transmitted under a certain condition regardless of the knowledge of the user. Consequently, the issue related to the color adjustment is communicated to the service provider at an early stage, facilitating early resolution of the issue.

In the above-described embodiment, if at least one of the image forming apparatus 10, the color adjustment system 20, the color adjustment assistance system 40, the device management system 50, or the service provider terminal 60 is implemented by execution of a program, the program is provided as previously stored in a memory such as a ROM.

Further, in the embodiment, a program executed on the image forming apparatus 10, the color adjustment system 20, the color adjustment assistance system 40, the device management system 50, or the service provider terminal 60 may be provided as recorded on a computer readable recording medium, such as a compact disc-ROM (CD-ROM), a flexible disk (FD), a CD-recordable (CD-R), or a DVD, in a file in an installable or executable format. In the embodiment, the program may be stored in a computer connected to a network such as the Internet and be provided as downloaded via the network, or may be provided or distributed via a network such as the Internet. In the embodiment, the program is configured as a module including at least one of the above-described functional units. As an actual hardware configuration, the CPU 701 or 801 reads and executes the program from the above-described storage device (e.g., the MEM-P 702 or the auxiliary storage device 708 or 805), to thereby load and generate the above-described functional unit on a main storage device.

The present disclosure relates to the following aspects.

According to a first aspect, an information processing system includes a color adjustment system and a color adjustment assistance system. The color adjustment system performs color adjustment on an image forming apparatus. The color adjustment assistance system provides a service for solving an issue related to the color adjustment. The information processing system includes an acquisition unit, a storage unit, a transmission unit, a first display control unit, and a notification unit. The acquisition unit acquires first information related to an operation of the image forming apparatus and second information related to the color adjustment by the color adjustment system. The storage unit stores the first information and the second information acquired by the acquisition unit. The transmission unit transmits a request for assistance with the issue related to the color adjustment to the color adjustment assistance system in accordance with an operation performed on an input unit by a user of the image forming apparatus. When the color adjustment assistance system receives the request, the first display control unit causes a first display device used by a service provider of the service to display an assistance screen that displays information for supporting resolution of the issue related to the color adjustment based on information corresponding to the request and included in the first information and the second information acquired by the acquisition unit. Further, when the color adjustment assistance system receives the request, the notification unit notifies the color adjustment system of a response input by the service provider as a response to the request.

According to a second aspect, the information processing system of the first aspect further includes a detection unit that detects occurrence of the issue related to the color adjustment when a particular condition is met. When the detection unit detects the occurrence of the issue related to the color adjustment, the transmission unit transmits the request for assistance to the color adjustment assistance system.

According to a third aspect, in the information processing system of the second aspect, the color adjustment system performs, as the color adjustment, first color adjustment to generate an output profile for the image forming apparatus. The detection unit detects occurrence of an issue related to the first color adjustment.

According to a fourth aspect, in the information processing system of the second aspect, the color adjustment system performs, as the color adjustment, second color adjustment to generate an input profile for each document data to be printed by the image forming apparatus. The detection unit detects occurrence of an issue related to the second color adjustment.

According to a fifth aspect, the information processing system of one of the first to fourth aspects further includes an analysis unit that analyzes the issue related to the color adjustment based on the first information and the second information acquired by the acquisition unit. The first display control unit causes the first display device to display a result of the analysis by the analysis unit on the assistance screen.

According to a sixth aspect, in the information processing system of the fifth aspect, the analysis unit automatically generates a comment as a draft of the response based on the result of the analysis.

According to a seventh aspect, the information processing system of one of the first to sixth aspects further includes a second display control unit. The second display control unit causes a second display device used by the user to display an assistance request screen that displays a result of the color adjustment based on the first information and the second information acquired by the acquisition unit. In accordance with an operation performed on the input unit by the user, the transmission unit transmits a comment input on the assistance request screen to the color adjustment assistance system together with the request. The first display control unit causes the first display device to display the comment input by the user and the response input by the service provider on the assistance screen as a history of interactive communication between the user and the service provider. The second display control unit causes the second display device to display the comment input by the user and the response input by the service provider on the assistance request screen as the history of interactive communication between the user and the service provider.

According to an eighth aspect, in the information processing system of one of the first to seventh aspects, the first display control unit causes the first display device to display, on the assistance screen, a graph that chronologically represents a result of the color adjustment based on the second information. The first display control unit further generates, as a file, an image of an area of the graph specified by the service provider. The notification unit notifies the color adjustment system of the file to as a part of the response.

According to a ninth aspect, in the information processing system of one of the first to eighth aspects, the first information includes at least one of an operating status of the image forming apparatus, a history of errors occurred in the image forming apparatus, or print settings information of document data and a color chart printed by the image forming apparatus.

According to a tenth aspect, in the information processing system of one of the first to ninth aspects, the second information includes at least one of a profile generated by the color adjustment system, read data read by an image reading apparatus used in the color adjustment, document data printed by the image forming apparatus, a history of operations performed on the image forming apparatus and the color adjustment system, a history of the color adjustment performed by the color adjustment system, or information of the image forming apparatus on which the color adjustment is performed.

According to an eleventh aspect, an information processing method is performed by an information processing system that includes a color adjustment system and a color adjustment assistance system. The color adjustment system performs color adjustment on an image forming apparatus. The color adjustment assistance system provides a service for solving an issue related to the color adjustment. The information processing method includes acquiring first information related to an operation of the image forming apparatus and second information related to the color adjustment by the color adjustment system, storing the acquired first information and the acquired second information in a storage unit, and transmitting a request for assistance with the issue related to the color adjustment to the color adjustment assistance system in accordance with an operation performed on an input unit by a user of the image forming apparatus. When the color adjustment assistance system receives the request, the information processing method further includes causing a display device used by a service provider of the service to display an assistance screen that displays information for supporting resolution of the issue related to the color adjustment based on information corresponding to the request and included in the acquired first information and the acquired second information, and notifying the color adjustment system of a response input by the service provider as a response to the request.

According to a twelfth aspect, a non-transitory recording medium stores a plurality of instructions which, when executed by one or more processors of a computer of a color adjustment assistance system, cause the one or more processors to perform an information processing method. The color adjustment assistance system communicates with a color adjustment system that performs color adjustment on an image forming apparatus. Further, the color adjustment assistance system provides a service for solving an issue related to the color adjustment. The information processing method includes acquiring first information related to an operation of the image forming apparatus and second information related to the color adjustment by the color adjustment system, storing the acquired first information and the acquired second information in a storage unit, and receiving from the color adjustment system a request for assistance with the issue related to the color adjustment in accordance with an operation performed on an input unit by a user of the image forming apparatus. In response to receipt of the request, the information processing method further includes causing a display device used by a service provider of the service to display an assistance screen that displays information for supporting resolution of the issue related to the color adjustment based on information corresponding to the request and included in the acquired first information and the acquired second information, and notifying the color adjustment system of a response input by the service provider as a response to the request.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information processing system comprising:
a first system to perform color adjustment on an image forming apparatus; and
a second system to provide a service related to the color adjustment,
the first system including first circuitry configured to transmit to the second system a request for assistance with an issue related to the color adjustment in accordance with an operation performed by a user of the image forming apparatus,
the second system including
second circuitry configured to acquire first information related to an operation of the image forming apparatus and second information related to the color adjustment, and
a memory that stores the first information and the second information, and
in response to receipt of the request, the second circuitry
causing a first display device used by a service provider of the service to display an assistance screen that displays information for supporting resolution of the issue related to the color adjustment based on information included in the first information and the second information and corresponding to the request, and
notifying the first system of a response input by the service provider as a response to the request.

2. The information processing system of claim 1, wherein the first circuitry
detects occurrence of the issue related to the color adjustment when a particular condition is met, and
in response to detection of the occurrence of the issue related to the color adjustment, transmits the request for assistance to the second system.

3. The information processing system of claim 2, wherein the first circuitry
performs, as the color adjustment, first color adjustment to generate an output profile for the image forming apparatus, and
detects occurrence of an issue related to the first color adjustment.

4. The information processing system of claim 2, wherein the first circuitry
performs, as the color adjustment, second color adjustment to generate an input profile for each document data to be printed by the image forming apparatus, and
detects occurrence of an issue related to the second color adjustment.

5. The information processing system of claim 1, wherein the second circuitry
analyzes the issue related to the color adjustment based on the first information and the second information, and
causes the first display device to display a result of the analysis on the assistance screen.

6. The information processing system of claim 5, wherein the second circuitry automatically generates a comment as a draft of the response based on the result of the analysis.

7. The information processing system of claim 1, wherein the first circuitry
causes a second display device used by the user to display an assistance request screen that displays a result of the color adjustment based on the first information and the second information, and
in accordance with an operation performed by the user, transmits a comment input on the assistance request screen to the second system together with the request,
wherein the second circuitry causes the first display device to display the comment input by the user and the response input by the service provider on the assistance screen as a history of interactive communication between the user and the service provider, and
wherein the first circuitry causes the second display device to display the comment input by the user and the response input by the service provider on the assistance request screen as the history of interactive communication between the user and the service provider.

8. The information processing system of claim 1, wherein the second circuitry
causes the first display device to display, on the assistance screen, a graph that chronologically represents a result of the color adjustment based on the second information,
generates, as a file, an image of an area of the graph specified by the service provider, and
transmits the file to the first system as a part of the response.

9. The information processing system of claim 1, wherein the first information includes at least one of an operating status of the image forming apparatus, a history of errors occurred in the image forming apparatus, or print settings information of document data and a color chart printed by the image forming apparatus.

10. The information processing system of claim 1, wherein the second information includes at least one of a profile generated by the first system, read data read by an image reading apparatus used in the color adjustment, document data printed by the image forming apparatus, a history of operations performed on the image forming apparatus and the first system, a history of the color adjustment performed by the first system, or information of the image forming apparatus on which the color adjustment is performed.

11. An information processing method comprising:
acquiring first information related to an operation of an image forming apparatus and second information related to color adjustment performed on the image forming apparatus; and
storing the first information and the second information in a memory;
in response to receipt of a request for assistance with an issue related to the color adjustment, the request being transmitted in accordance with an operation performed by a user of the image forming apparatus, the method further comprising:
causing a display device used by a service provider of a service related to the color adjustment to display an assistance screen that displays information for supporting resolution of the issue related to the color adjustment based on information included in the first information and the second information and corresponding to the request; and
notifying a response input by the service provider as a response to the request.

12. A non-transitory recording medium storing a plurality of instructions which, when executed by one or more processors, causes the one or more processors to perform an information processing method comprising:
acquiring first information related to an operation of an image forming apparatus and second information related to color adjustment performed on the image forming apparatus; and
storing the first information and the second information in a memory;
in response to receipt of a request for assistance with an issue related to the color adjustment, the request being transmitted in accordance with an operation performed by a user of the image forming apparatus, the method further comprising:
causing a display device used by a service provider of a service related to the color adjustment to display an assistance screen that displays information for supporting resolution of the issue related to the color adjustment based on information included in the first information and the second information and corresponding to the request; and
notifying a response input by the service provider as a response to the request.
